(19) United States
(12) Patent Application Publication
(10) Pub. No.: US 2026/0343525 A1
(43) Pub. Date: Oct. 29, 2026

(54) Physical Data Channel Scheduling

(71) Applicant: Telefonaktiebolaget LM Ericsson (publ), Stockholm (SE)

(72) Inventors: Giuseppe Caso, Stockholm (SE); Alexey Shapin, Linköping (SE); Sorour Falahati, Stockholm (SE); Du Ho Kang, Sollentuna (SE); Jose Luis Pradas, Stockholm (SE); Richard Tano, Stockholm (SE); Jonas Fröberg Olsson, Ljungsbro (SE); Bikramjit Singh, Raasepori (FI)

(21) Appl. No.: 19/102,483

(22) PCT Filed: Aug. 10, 2023
(86) PCT No.: PCT/EP2023/072184

§ 371 Date: Feb. 10, 2025

Related U.S. Application Data
(60) Provisional application No. 63/396,715, filed on Aug. 10, 2022.

(51) Int. Cl. H04W 72/12; H04L 1/00; H04W 72/0446; H04W 72/20; H04W 76/20

(52) U.S. Cl. CPC H04W 72/12; H04L 1/0003; H04W 72/0446; H04W 72/20; H04W 76/20

(57) ABSTRACT

A communication device (12) receives radio resource control, RRC, signaling (22) indicating how a value of a transmission parameter (P) (e.g., a modulation and coding scheme, MCS, parameter) is to be adapted across multiple physical data channels (20) scheduled by a single physical layer control message (16) for the communication device (12). The RRC signaling (22) may for example indicate a rule, formula, sequence, or pattern according to which the value of the transmission parameter (P) is to be adapted. Regardless, the communication device (12) may accordingly receive a physical layer control message (16) that schedules multiple physical data channels (20) for the communication device (12), and then transmit or receive transmissions on the multiple physical data channels (20) scheduled by the physical layer control message (16), with the value of the transmission parameter (P) adapted across the multiple physical data channels (20) according to the received RRC signaling (22).

### TECHNICAL FIELD

The present application relates generally to a communication network, and relates more particularly to scheduling physical data channels in such a network.

### BACKGROUND

5G New Radio (NR) is expected to provide high Quality of Service (QoS) and Quality of Experience (QoE) to enhanced Mobile Broadband (eMBB), Ultra-Reliable Low-Latency Communication (URLLC), and massive Machine-Type Communication (mMTC) use cases. Therefore, since its introduction by 3GPP in Release 15 (Rel-15), 5G NR includes several protocol enhancements and improved mechanisms for accessing radio resources, compared to 4G Long Term Evolution (LTE).

5G NR is a scheduled system. This means the parameters for data exchange in downlink (DL) and uplink (UL) are assigned to the User Equipment (UE) by the scheduling function in the gNBs. The assigned parameters include, for example, time/frequency allocations and Modulation and Coding Scheme (MCS). Dynamic scheduling is the main mode when the gNB provides variable transmission/reception parameters to the UE depending on system conditions, e.g., network congestion, channel conditions, amount of data in the buffers, and so on. Hence, dynamic scheduling enables full flexibility, i.e., timely modification of transmission/reception parameters, which is beneficial in most cases but may incur additional delay due to the need for evaluating such parameters in each Transmission Time Interval (TTI). Moreover, dynamic scheduling requires a dedicated Downlink Control Information (DCI) message to advertise each allocated set of parameters. Hence, further mechanisms were developed in Rel-16 and Rel-17 to reduce the overhead caused by multiple DCIs, including so-called multi-slot scheduling, also often referred to as multi-PxSCH scheduling. Note that multi-PxSCH scheduling can be referred to as multi-PDSCH in DL or multi-PUSCH in UL, where PDSCH is the Physical Downlink Shared Channel and PUSCH is the Physical Uplink Shared Channel. The allocation can be a part of spectrum types, such as, Frequency Division Duplexing (FDD), Time Division Duplexing (TDD), low band, mid band, high band, Frequency Range 1 (FR1), Frequency Range 2 (FR2), licensed spectrum, unlicensed/shared spectrum, beyond 52 GHz, etc. (See E. Dahlman et al., “5G NR—The Next Generation Wireless Access Technology,” 2^{nd} Edition, Academic Press, 2021).

Standardized multi-PxSCH scheduling allows for using a single DCI for granting the transmission/reception of up to 8 PxSCHs over consecutive, possibly non-contiguous, DL or UL slots. Compared to normal dynamic scheduling, this results in reducing the number of DCIs but comes with the cost of lower scheduling flexibility. Indeed, multi-PxSCH does not allow changing the MCS value and frequency allocation (i.e., how many and which Resource Blocks (RBs)) used for the PDSCHs or PUSCHs scheduled by the same DCI. Multi-PxSCH allows instead to change the time allocation for the PxSCHs scheduled together. This is possible because the DCI points at a row of a Radio Resource Control (RRC) configured time-domain resource allocation (TDRA) table, where a different Start and Length Indicator Value (SLIV) can be given to each PxSCH.

eXtended Reality (XR) includes services provided by computer technologies and wearables that allow for human-machine interaction in real/virtual mixed environments. XR includes Virtual Reality (VR), Augmented Reality (AR), Mixed Reality (MR), Cloud Gaming, and the areas interpolated among them (See F. Alriksson et al., “Ericsson Technology Review—XR and 5G: Extended reality at scale with time-critical communication”). As such, XR may be considered a mixed eMBB/URLLC service; as reported in Table 1. XR traffic is a mixture of heterogeneous UL/DL data flows, including video, audio, and control traffic (See 3GPP TR 38.838 V17.0.0).

TABLE 1
XR traffic characteristics and requirements identified by 3GPP

| | | | Packet | Packet Delay |
|---|---|---|---|---|
| | | Data rate | (frame) | Budget |
| | | [Mbps] | rate [fps] | (PDB) [ms] |
| DL | AR/VR Video | 30 | 60 | 10 |
| | Cloud Gaming | 30 | 60 | 15 |
| UL | Pose/control | 0.2 | 250 | 10 |
| | Video (Scene) | 10 | 60 | 30 |

Table 1 highlights that XR traffic flows have different characteristics (e.g., packet rate in frame per second [fps] and bit rate in bit per second [bps]) and requirements in terms of (application) packet delay budget (PDB) [ms]. Among XR flows, DL video and UL scene traffic are periodic (with possible jitter particularly in DL) and have variable large-sized application packets.

For these high date rate flows, the gNB may often need to allocate several PxSCHs over different slots to deliver all of the Internet Protocol (IP) packets belonging to an application packet (e.g., a video frame). With normal dynamic scheduling, this would require sending multiple DCIs to the user equipment (UE) (one DCI for each PxSCH). Compared to normal dynamic scheduling, multi-PxSCH scheduling can enable control signalling reduction at the cost of lower scheduling flexibility. In an XR context, multi-PxSCH control signalling reduction can be beneficial as it may free up additional resources for data, but low scheduling flexibility can be detrimental under variable system conditions.

Enhancements to multi-PxSCH in an XR context target higher flexibility while maintaining reduced control signalling, e.g., allowing different configurations per PDSCH/PUSCH. See 3GPP TSG RAN WG1 #109-e RAN1 Chair's Notes, May 9th-20th, 2022. Challenges exist, though, in providing flexibility into the multi-PxSCH framework in an efficient way (e.g., in terms of additional control signalling) so as to actually realize achievable gains of such enhancements over normal dynamic scheduling and current multi-PxSCH.

More particularly in this regard, in Rel-17, multi-PxSCH scheduling allows the use of a single DCI for allocating the parameters for transmitting (UL) or receiving (DL) up to 8 PxSCHs in non-consecutive slots. This advantageously reduces control signaling compared to dynamic scheduling with single PxSCH allocation. However, it comes with the cost of lower flexibility, limiting the potential of multi-PxSCH for XR services, where multi-PxSCH scheduling can be often used to schedule big chunks of time-critical data.

### SUMMARY

Some embodiments herein enhance multi-PxSCH scheduling flexibility in an efficient manner, e.g., maintaining a reasonable tradeoff between flexibility and required control signalling. Embodiments in this regard include methods, signalling, and parameters for enhancing the flexibility of multi-PxSCH scheduling with low control overhead, e.g., aiming to better deal with variability of channel conditions, traffic characteristics, and service requirements.

Some embodiments for example enable multi-PxSCH flexibility via patterns, where a user equipment (UE) infers and applies a specific pattern for modifying one or more parameters for transmitting/receiving the PxSCHs scheduled by the same DCI (e.g., MCS values and/or RBs). The patterns may for example be defined via a set of parameters shared by the network to the UE. In this case, then, some embodiments herein define patterns for modifying multi-PxSCH transmission/reception parameters at the UE and network side, e.g., modifying MCS values and/or RBs over the course of the multiple PxSCHs scheduled by a single DCI. Embodiments herein also specify the derivation and use of such patterns at the UE side.

Some embodiments herein thereby enhance multi-PxSCH flexibility in a lightweight manner. Compared to standard multi-PxSCH, therefore, some embodiments introduce flexibility in modifying transmission/reception parameters for the PxSCHs scheduled by the same DCI (e.g., MCS values and/or RBs), while maintaining a satisfactory tradeoff with control signalling, leading to better adaptation of multi-PxSCH scheduling to variable system conditions, and traffic characteristics and requirements. Compared to normal dynamic scheduling, some embodiments herein reduce signalling overhead in scenarios where it is expected that multiple PxSCHs are needed to finalize the transmission of large-size application data packets, e.g., XR high data rate flows in DL (video) and UL (scene). Signalling reduction may eventually be beneficial for system capacity improvements.

One or more embodiments for example allow adaptation of MCS values and/or RBs allocated for the PxSCHs scheduled by the same DCI.

Some embodiments herein thereby avoid fixing transmission/reception parameters for all PxSCHs scheduled by the same DCI. Some embodiments for instance select the number of RBs and MCS value such that a target reliability is maintained and, at the same time, the number of padding bits in the last PxSCH transmission is minimized. Some embodiments are able to do so even if resource block grouping (RBG) is used, i.e., the scheduling granularity in frequency is >1 RB. In this case, when the transport block (TB) size is only a few bits smaller than data in a buffer, an addition of one RBG in allocation for all PxSCHs increases the TB size which can be considerably bigger than the amount of data in the buffer. The flexibility provided by some embodiments herein accounts for this in a way that avoids the last transmission in the set carrying a lot of padding bits. Some embodiments for example arrange the amount of data over the different PxSCHs to minimize padding bits.

The flexibility of some embodiments herein addresses limitations of known approaches to multi-PxSCH scheduling where link adaptation decisions for transmissions are made quite ahead of time without the ability to account for the possibility of the channel state changing considerably at the last transmission in a set. Some embodiments for example enable adaptation of the MCS value across the scheduled PxSCHs, e.g., lowering down the MSC over the course of the scheduled PxSCHs to compensate for such effect.

Some embodiments herein thereby provide flexibility that increases network capacity compared to normal dynamic scheduling and existing multi-PxSCH in XR scenarios. This may expand use for XR services and provide gains as a result of control signalling reduction.

Generally, some embodiments herein include a method performed by a communication device. The method comprises receiving control signaling indicating that and/or how a value of a transmission parameter is to be adapted across multiple physical data channels scheduled by a single physical layer control message for the communication device.

In some embodiments, the control signaling indicates the transmission parameter whose value is to be adapted across multiple physical data channels scheduled by a single physical layer control message for the communication device.

In some embodiments, the control signaling indicates a rule, formula, sequence, or pattern according to which the value of the transmission parameter is to be adapted across multiple physical data channels scheduled by a single physical layer control message for the communication device. In some embodiments, according to the rule, formula, sequence, or pattern, the value of the transmission parameter is to be incremented or decremented across multiple physical data channels scheduled by a single physical layer control message for the communication device. In some embodiments, the control signaling explicitly indicates the rule, formula, sequence, or pattern. In other embodiments, the control signaling implicitly indicates the rule, formula, sequence, or pattern by indicating an index mapped to the rule, formula, sequence, or pattern, with different possible indices being mapped to respective rules, formulas, sequences, or patterns. In some embodiments, the control signaling implicitly indicates the rule, formula, sequence, or pattern by indicating an index mapped to the rule. In this case, the index mapped to the rule is an index into a time domain resource allocation table. In some embodiments, the single physical layer control message indicates a nominal value for the parameter, and the control signaling indicates a sequence of N offset values. In some embodiments, the value of the parameter for the Nth scheduled physical data channel is to be offset from the nominal value by the Nth offset value in the indicated sequence.

In some embodiments, the control signaling indicates how often the value of the transmission parameter is to be adapted across multiple physical data channels scheduled by a single physical layer control message for the communication device.

In some embodiments, the control signaling indicates one or more respective values of one or more variables in a rule, formula, sequence, or pattern according to which the value of the transmission parameter is to be adapted across multiple physical data channels scheduled by a single physical layer control message for the communication device. In some embodiments, the one or more variables include a delta variable. In this case, the value of the transmission parameter is to be adapted by the value of the delta variable between successive ones of multiple physical data channels scheduled by a single physical layer control message for the communication device. In some embodiments, the single physical layer control message indicates the value of the transmission parameter for an earliest scheduled one of the multiple physical data channels, and the one or more variables include a first delta variable and a delta adaptation variable. In some embodiments, the value of the transmission parameter is to be adapted by the value of the first delta variable between the earliest scheduled one of the multiple physical data channels and a second earliest scheduled one of the multiple physical data channels. In some embodiments, the value of the transmission parameter is to be adapted by the value of a second delta variable between successive ones of multiple physical data channels after the second earliest scheduled one of the multiple physical data channels. In this case, the second delta variable is a function of the value of the delta adaptation variable. In some embodiments,

$${P}_{2 nd PDCH} = {P}_{1 st PDCH} - {C}_{2 nd PDCH}$$

$${C}_{xth PDCH} = {C}_{2 nd PDCH} * [ ( x - 1 ) * {Δ}_{C} ]$$

$${P}_{xth PDCH} = {P}_{( x - 1 ) th PDCH} - {C}_{xth PDCH}$$

where P_{1st PDCH} is the value of the parameter P for the earliest scheduled one of the multiple physical data channels, P_{2nd PDCH} is the value of the parameter P for the second earliest scheduled one of the multiple physical data channels, P_{xth PDCH} is the value of the parameter P for the xth scheduled one of the multiple physical data channels, C_{2nd PxSCH} is the first delta variable, Δ_{C} is the delta adaptation variable, and C_{xth PDCH} is the second delta variable. In some embodiments, the one or more variables include an adaptation frequency variable N. In this case, the value of the transmission parameter is to be adapted every Nth successive one of multiple physical data channels scheduled by a single physical layer control message for the communication device. In some embodiments, the one or more variables include a first channel variable X and a last channel variable Y. In this case, the value of the transmission parameter is to be adapted across physical data channels between the Xth scheduled one of the multiple physical data channels and the Yth scheduled one of the multiple physical data channels. In some embodiments, the one or more variables include a minimum parameter value variable THₘᵢₙ and a maximum parameter value variable THₘₐₓ. In this case, the value of the transmission parameter is to be adapted across multiple physical data channels scheduled by a single physical layer control message for the communication device, subjected to a constraint that the value of the transmission parameter is not to fall below the minimum parameter value variable THₘᵢₙ and is not to exceed the maximum parameter value variable THₘₐₓ.

In some embodiments, the single physical layer control message includes a field indicating that, or whether, the value of the parameter is to be adapted across the multiple physical data channels scheduled by the single physical layer control message.

In some embodiments, the single physical layer control message is scrambled with a radio network temporary identifier that indicates the value of the parameter is to be adapted across the multiple physical data channels scheduled by the single physical layer control message.

In some embodiments, the control signaling includes radio resource control, RRC, signaling.

In some embodiments, at least a portion of the control signaling is included in the single physical layer control message.

In some embodiments, the control signaling includes a physical layer control message.

In some embodiments, the single physical layer control message is a downlink control information, DCI, message.

In some embodiments, the parameter is a modulation and coding scheme, MCS, parameter.

In some embodiments, the parameter is a resource block, RB, allocation parameter.

In some embodiments, the parameter is a frequency domain resource allocation parameter.

In some embodiments, multiple physical data channels scheduled by a single physical layer control message comprise multiple physical data channels scheduled in different time domain resources.

In some embodiments, multiple physical data channels scheduled by a single physical layer control message correspond to different respective time domain resource allocations indicated for the communication device by the physical layer control message.

In some embodiments, the control signaling indicates that and/or how a value of the parameter is to be adapted across multiple physical data channels scheduled in one cell by a single physical layer control message for the communication device.

In some embodiments, the multiple physical data channels are multiple physical downlink data channels, multiple physical uplink data channels, or multiple physical sidelink data channels.

In some embodiments, the multiple physical data channels are multiple Physical Downlink Shared Channels, PDSCH or multiple Physical Uplink Shared Channels, PUSCHs.

In some embodiments, the multiple physical data channels carry extended reality, XR, application data.

In some embodiments, the method further comprises transmitting an acknowledgement acknowledging reception of the control signaling. In some embodiments, the acknowledgement is included in a medium access control, MAC, control element, CE.

In some embodiments, the method further comprises receiving a physical layer control message that schedules multiple physical data channels for the communication device. In this case, the method further comprises transmitting or receiving transmissions on the multiple physical data channels scheduled by the physical layer control message, with the value of the transmission parameter adapted across the multiple physical data channels according to the received control signaling. In some embodiments, the method further comprises adapting the value of the transmission parameter across the multiple physical data channels according to the received control signaling.

In some embodiments, the control signaling is received from a network node in a communication network.

Other embodiments herein include a method performed by a network node in a communication network. The method comprises transmitting, to a communication device, control signaling indicating that and/or how a value of a transmission parameter is to be adapted across multiple physical data channels scheduled by a single physical layer control message for the communication device.

In some embodiments, the control signaling indicates the transmission parameter whose value is to be adapted across multiple physical data channels scheduled by a single physical layer control message for the communication device.

In some embodiments, the control signaling indicates a rule, formula, sequence, or pattern according to which the value of the transmission parameter is to be adapted across multiple physical data channels scheduled by a single physical layer control message for the communication device. In some embodiments, according to the rule, formula, sequence, or pattern, the value of the transmission parameter is to be incremented or decremented across multiple physical data channels scheduled by a single physical layer control message for the communication device. In some embodiments, the control signaling explicitly indicates the rule, formula, sequence, or pattern. In other embodiments, the control signaling implicitly indicates the rule, formula, sequence, or pattern by indicating an index mapped to the rule, formula, sequence, or pattern, with different possible indices being mapped to respective rules, formulas, sequences, or patterns. In some embodiments, the control signaling implicitly indicates the rule, formula, sequence, or pattern by indicating an index mapped to the rule, wherein the index mapped to the rule is an index into a time domain resource allocation table. In some embodiments, the single physical layer control message indicates a nominal value for the parameter, and the control signaling indicates a sequence of N offset values. In this case, the value of the parameter for the Nth scheduled physical data channel is to be offset from the nominal value by the Nth offset value in the indicated sequence.

In some embodiments, the control signaling indicates how often the value of the transmission parameter is to be adapted across multiple physical data channels scheduled by a single physical layer control message for the communication device.

In some embodiments, the control signaling indicates one or more respective values of one or more variables in a rule, formula, sequence, or pattern according to which the value of the transmission parameter is to be adapted across multiple physical data channels scheduled by a single physical layer control message for the communication device. In some embodiments, the one or more variables include a delta variable. In this case, the value of the transmission parameter is to be adapted by the value of the delta variable between successive ones of multiple physical data channels scheduled by a single physical layer control message for the communication device. In some embodiments, the single physical layer control message indicates the value of the transmission parameter for an earliest scheduled one of the multiple physical data channels, and the one or more variables include a first delta variable and a delta adaptation variable. In some embodiments, the value of the transmission parameter is to be adapted by the value of the first delta variable between the earliest scheduled one of the multiple physical data channels and a second earliest scheduled one of the multiple physical data channels. In some embodiments, the value of the transmission parameter is to be adapted by the value of a second delta variable between successive ones of multiple physical data channels after the second earliest scheduled one of the multiple physical data channels. In this case, the second delta variable is a function of the value of the delta adaptation variable. In some embodiments,

$${P}_{2 nd PDCH} = {P}_{1 st PDCH} - {C}_{2 nd PDCH}$$

$${C}_{xth PDCH} = {C}_{2 nd PDCH} * [ ( x - 1 ) * {Δ}_{C} ]$$

$${P}_{xth PDCH} = {P}_{( x - 1 ) th PDCH} - {C}_{xth PDCH}$$

where P_{1st PDCH} is the value of the parameter P for the earliest scheduled one of the multiple physical data channels, P_{2nd PDCH} is the value of the parameter P for the second earliest scheduled one of the multiple physical data channels, P_{xth PDCH} is the value of the parameter P for the xth scheduled one of the multiple physical data channels, C_{2nd PxSCH} is the first delta variable, Ac is the delta adaptation variable, and C_{xth PDCH} is the second delta variable. In some embodiments, the one or more variables include an adaptation frequency variable N. In this case, the value of the transmission parameter is to be adapted every Nth successive one of multiple physical data channels scheduled by a single physical layer control message for the communication device. In some embodiments, the one or more variables include a first channel variable X and a last channel variable Y. In this case, the value of the transmission parameter is to be adapted across physical data channels between the Xth scheduled one of the multiple physical data channels and the Yth scheduled one of the multiple physical data channels. In some embodiments, the one or more variables include a minimum parameter value variable THₘᵢₙ and a maximum parameter value variable THₘₐₓ. In this case, the value of the transmission parameter is to be adapted across multiple physical data channels scheduled by a single physical layer control message for the communication device, subjected to a constraint that the value of the transmission parameter is not to fall below the minimum parameter value variable THₘᵢₙ and is not to exceed the maximum parameter value variable THₘₐₓ.

In some embodiments, the single physical layer control message includes a field indicating that, or whether, the value of the parameter is to be adapted across the multiple physical data channels scheduled by the single physical layer control message.

In some embodiments, the single physical layer control message is scrambled with a radio network temporary identifier that indicates the value of the parameter is to be adapted across the multiple physical data channels scheduled by the single physical layer control message.

In some embodiments, the control signaling includes radio resource control, RRC, signaling.

In some embodiments, at least a portion of the control signaling is included in the single physical layer control message.

In some embodiments, the control signaling includes a physical layer control message.

In some embodiments, the single physical layer control message is a downlink control information, DCI, message.

In some embodiments, the parameter is a resource block, RB, allocation parameter.

In some embodiments, the parameter is a frequency domain resource allocation parameter.

In some embodiments, multiple physical data channels scheduled by a single physical layer control message comprise multiple physical data channels scheduled in different time domain resources.

In some embodiments, multiple physical data channels scheduled by a single physical layer control message correspond to different respective time domain resource allocations indicated for the communication device by the physical layer control message.

In some embodiments, the control signaling indicates that and/or how a value of the parameter is to be adapted across multiple physical data channels scheduled in one cell by a single physical layer control message for the communication device.

In some embodiments, the multiple physical data channels are multiple physical downlink data channels, multiple physical uplink data channels, or multiple physical sidelink data channels.

In some embodiments, the multiple physical data channels are multiple Physical Downlink Shared Channels, PDSCH or multiple Physical Uplink Shared Channels, PUSCHs.

In some embodiments, the multiple physical data channels carry extended reality, XR, application data.

In some embodiments, the method further comprises transmitting a physical layer control message that schedules multiple physical data channels for the communication device. In this case, the method further comprises transmitting or receiving transmissions on the multiple physical data channels scheduled by the physical layer control message, with the value of the transmission parameter adapted across the multiple physical data channels according to the received control signaling. In some embodiments, the method further comprises adapting the value of the transmission parameter across the multiple physical data channels according to the received control signaling.

In some embodiments, the method further comprises deciding that and/or how the value the transmission parameter is to be adapted across multiple physical data channels scheduled by a single physical layer control message for the communication device. In this case, the method further comprises generating the control signaling according to said deciding.

Embodiments herein also include corresponding apparatus, computer programs, and carriers of those computer programs.

### BRIEF DESCRIPTION OF THE DRAWINGS

FIG. 1 is a block diagram of a communication device according to some embodiments.

FIG. 2 is a block diagram of PxSCHs in a set scheduled by a DCI having different parameter values.

FIG. 3 is a logic flow diagram of a method performed by a communication device in accordance with particular embodiments.

FIG. 4 is a logic flow diagram of a method performed by a network node in a communication network in accordance with other particular embodiments.

FIG. 5 is a block diagram of a communication device according to some embodiments.

FIG. 6 is a block diagram of a network node according to some embodiments.

FIG. 7 is a block diagram of a communication system in accordance with some embodiments.

FIG. 8 is a block diagram of a user equipment according to some embodiments.

FIG. 9 is a block diagram of a network node according to some embodiments.

FIG. 10 is a block diagram of a host according to some embodiments.

FIG. 11 is a block diagram of a virtualization environment according to some embodiments.

FIG. 12 is a block diagram of a host communicating via a network node with a UE over a partially wireless connection in accordance with some embodiments.

### DETAILED DESCRIPTION

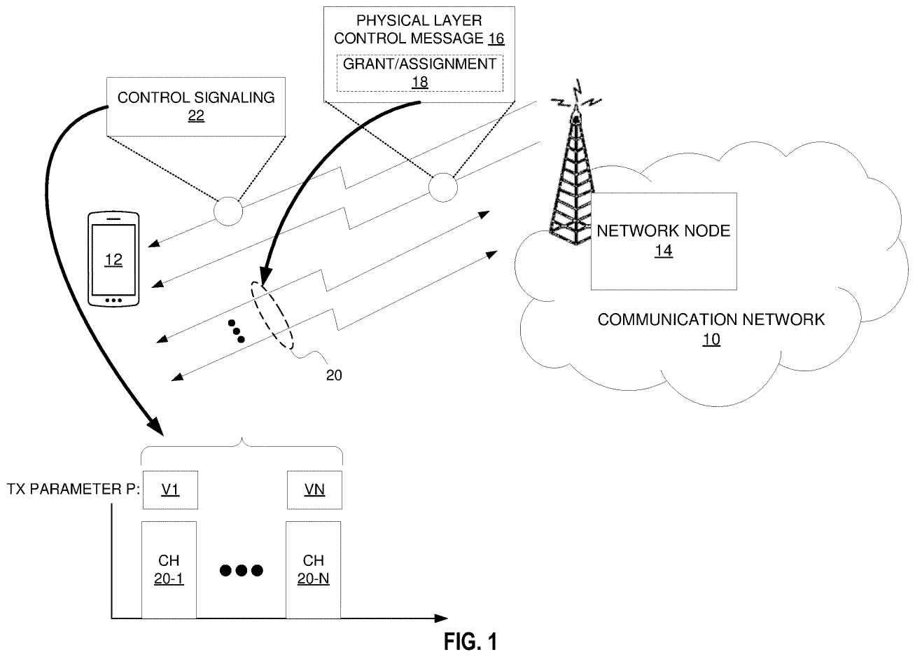

FIG. 1 shows a communication device 12 according to some embodiments. The communication device 12 as shown is configured to receive communication service from a communication network 10, e.g., a 5G or New Radio (NR) network. The communication network 10 for example includes a network node 14, e.g., a base station, configured to serve the communication device 12.

The communication device 12 as shown is capable of receiving a single physical layer control message 16 (e.g., a Downlink Control Information, DCI, message) that schedules multiple physical data channels 20-1 . . . 20-N, collectively referred to as physical data channels 20, e.g., in one cell. In some embodiments, the physical data channels 20 may be scheduled in different time domain resources and/or correspond to different respective time domain resource allocations. The single physical layer control message 16 may schedule multiple Physical Downlink Shared Channels (PDSCHs), multiple Physical Uplink Shared Channels (PUSCHs), or the like, e.g., in which case the single physical layer control message 16 may perform multi-PxSCH scheduling as described herein. In these and other embodiments, the physical layer control message 16 may convey, contain, or otherwise provide multiple scheduling grants or multiple scheduling assignments 18. Note that it may also be said that the single physical layer control message 16 schedules transmissions on the multiple physical data channels 20. In these and other embodiments, the physical data channels 20 may carry extended reality (XR) application data.

Notably, according to embodiments herein, the communication device 12 is configured to receive control signaling 22 indicating that and/or how a value of a transmission (TX) parameter P is to be adapted across the multiple physical data channels 20 scheduled by a single physical layer control message 16. As shown in FIG. 1, then, the TX parameter P may have values V1 . . . VN across the respective physical data channels 20-1 . . . 20-N scheduled by a physical layer control message 16, where at least some of those values V1 . . . VN may be different such that the value of the parameter P varies or adapts across the physical data channels 20. In an example where the TX parameter P is a modulation and coding scheme (MCS) parameter, then, the control signaling 22 indicates that and/or how a value of the MCS parameter is to be adapted across the multiple physical data channels 20 scheduled by a single physical layer control message 16. In another example where the TX parameter P is a resource block (RB) allocation parameter, the control signaling 22 indicates that and/or how a value of the RB allocation parameter is to be adapted across the multiple physical data channels 20 scheduled by a single physical layer control message 16.

In some embodiments, the control signaling 22 is specific to a certain physical layer control message 16, so that the control signaling 22 is specifically applicable to the multiple physical data channels scheduled by that certain physical layer control message 16. In this case, for example, at least a portion of the control signaling 22 may be included in the certain physical layer control message 16.

In other embodiments, the control signaling 22 is generally applicable to each individual one of multiple physical layer control messages 16, so that the control signaling is applicable to the multiple physical data channels scheduled by each of those multiple physical layer control messages 16. For example, the control signaling 22 may be conveyed to the communication device 12 in advance, e.g., via Radio Resource Control (RRC) signaling, with the understanding that the control signaling 22 is to govern adaptation of the value of the transmission parameter P across multiple physical data channels scheduled by any single physical layer control message 16 that the communication device 12 may receive thereafter.

Regardless, in some embodiments, the control signaling 22 indicates the transmission parameter P whose value is to be adapted across multiple physical data channels 20 scheduled by a single physical layer control message 16.

Alternatively or additionally, the control signaling 22 may indicate how the value of the transmission parameter P is to be adapted. For example, the control signaling 22 may indicate a rule, formula, sequence, or pattern according to which the value of the transmission parameter P is to be adapted across multiple physical data channels 20 scheduled by a single physical layer control message 16 for the communication device 12. In one such embodiment, according to the rule, formula, sequence, or pattern, the value of the transmission parameter P is to be incremented or decremented across multiple physical data channels scheduled 20 by a single physical layer control message 16 for the communication device 12. Regardless, in these and other embodiments, the control signaling 22 may indicate one or more respective values of one or more variables in the rule, formula, sequence, or pattern.

As another example, the control signaling 22 may indicate how often the value of the transmission parameter P is to be adapted across multiple physical data channels 20 scheduled by a single physical layer control message 16.

Some embodiments herein will now be described in an example where the communication device 12 is a user equipment (UE), the communication network 10 is a 5G network, the physical layer control message 16 is a DCI message, the network node 14 is a gNB, and the physical data channels 20 are PxSCHs.

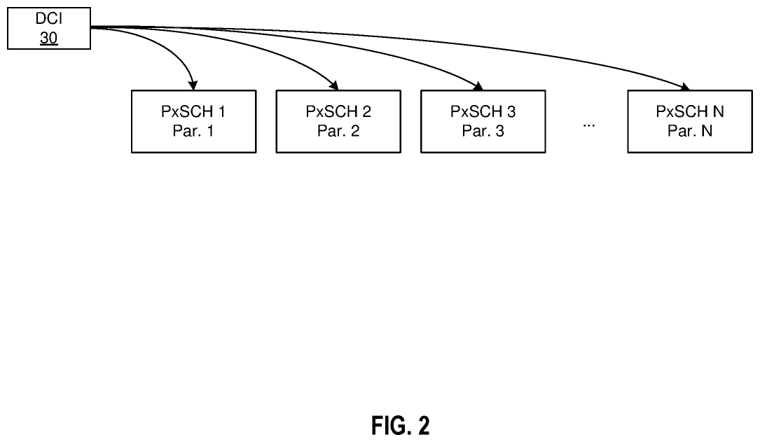

Consider in this regard a scenario where a UE receives a DCI that schedules a set of PUSCHs or PDSCHs. In this scenario, some embodiments herein enable modification and use of different values of a transmission/reception parameter over the course of the PUSCHs/PDSCHs scheduled by the DCI, e.g., modification and use of different MCS values and/or RBs for one PxSCH, a sub-set of PxSCHs, or all PxSCHs in the set scheduled by the DCI. An example where all PxSCHs in the set scheduled by the DCI have different parameter values is illustrated in FIG. 2. As shown, one DCI 30 schedules a set of N PxSCHs. In the nth PxSCH scheduled by the DCI 30, the transmission/reception parameter is shown as having parameter value n.

More particularly, some embodiments provide modification of transmission/reception parameter values for multi-PxSCH based on one or a combination of the following: (i) one or a set of novel RRC parameters provided to the UE; (ii) existing DCI content and/or new DCI fields; (iii) rules and/or Tables in a governing standardized specification. (i) and (ii) here provide examples of the control signaling 22 in FIG. 1.

### One or a Set of Novel RRC Parameters Provided to the UE

Consider first embodiments where a set of RRC parameters indicates that and/or how the value of a transmission/reception parameter is to be modified across the PxSCHs scheduled by the same DCI, e.g., where the set of RRC parameters is an example of the control signaling 22 in FIG. 1.

In one embodiment, the set of RRC parameters contains at least one parameter indicating which transmission/reception parameter should have its value modified across the PxSCHs scheduled by the same DCI, e.g., MCS values, RBs, both, or none.

For illustrative purposes, this and the following embodiments are described through an example where it is assumed that multi-PxSCH DCIs are used to schedule N_{sched PxSCHs} ∈[1,8] PxSCHs, and the transmission/reception parameter whose value is to be modified across the PxSCHs is the MCS. Further examples covering the modification of the value of RB allocation are provided below. Following this example, the RRC parameter defined in this embodiment could indicate that:
“MCS values should be modified across the N_{sched PxSCHs} PxSCHs scheduled by the same DCI”

In another embodiment, the set of RRC parameters indicates how the value of the transmission/reception parameter is to be modified across the PxSCHs scheduled by the same DCI. For example, the set of RRC parameters may contain at least one parameter indicating how to determine a pattern to use in modifying the value of a transmission/reception parameter across the PxSCHs scheduled by the same DCI.

Following the above example, this RRC parameter could indicate that:
“MCS values should be modified using a decremental rule”

In another embodiment, the set of RRC parameters indicates one or more respective values of one or more variables in a rule, formula, sequence, or pattern according to which the value of the transmission/reception parameter is to be modified across the PxSCHs scheduled by the same DCI. For example, the set of RRC parameters may contain at least one parameter indicating the numerical value, C_{2nd PxSCH}≥0, to be used the first time the value of a transmission/reception parameter is modified across the PxSCHs scheduled by the same DCI. C_{2nd PxSCH} may also be referred to as a delta variable, where the value of the transmission/reception parameter is modified by the value of the delta variable (C_{2nd PxSCH}) between successive the earliest scheduled PxSCH and the second earliest scheduled PxSCH, among the PxSCHs scheduled by the same DCI.

Following the above example, and assuming that the DCI provides the MCS value for the first scheduled PxSCH (MCS_{1st PxSCH}), then the C_{2nd PxSCH} parameter allows to determine the MCS value for the second scheduled PxSCH, as follows:

$${MCS}_{2 nd PxSCH} = {MCS}_{1 st PxSCH} - {C}_{2 nd PxSCH}$$

In another embodiment, the set of RRC parameters contains at least one parameter indicating a numerical value, Δ_{C}≥1, to be used to change the C_{2nd PxSCH} parameter the x^{th} time (x∈[3, N_{sched PxSCHs}]) the value of a transmission/reception parameter is modified across the PxSCHs scheduled by the same DCI. Δ_{C} may also be referred to as a delta adaptation parameter.

Following the above example, the Δ_{C} parameter allows to determine the MCS value for the x^{th} scheduled PxSCH, as follows:

$${C}_{xth PxSCH} = {C}_{2 nd PxSCH} * [ ( x - 1 ) * {Δ}_{C} ]$$

$${MCS}_{xth PxSCH} = {MCS}_{( x - 1 ) th PxSCH} - {C}_{xth PxSCH}$$

In this case, C_{xth PDCH} may be referred to as a second delta variable. The value of the transmission/reception parameter is modified by the value of this second delta variable C_{xth PDCH} between successive ones of the PxSCH after the second earliest scheduled PxSCH, where the second delta variable C_{xth PDCH} is a function of the value of the delta adaptation variable Ac.

In another embodiment, the set of RRC parameters contains at least one parameter indicating a numerical value, N_{updt PxSCHs}≥1, to be used to regulate how often the value of a transmission/reception parameter is modified across the PxSCHs scheduled by the same DCI.

Following the above example, the N_{updt PxSCHs} parameter could indicate that:
“MCS values should be modified every N_{updt PxSCHs} PxSCHs”
   Accordingly, N_{updt PxSCHs} may also be referred to as an adaptation frequency variable with a value of N, where the value of the transmission/reception parameter is to be adapted every Nth successive PxSCH.

In another embodiment, the set of RRC parameters contains at least a set of two parameters indicating two numerical values, N_{min PxSCH}≥1 and N_{max PxSCH}≥N_{min PxSCH}. These values indicate the first and last PxSCHs of the group of PxSCHs for which the value of a transmission/reception parameter is modified, across all the PxSCHs scheduled by the same DCI.

Following the above example, the N_{min PxSCH} and N_{max PxSCH} parameters could indicate that:
“MCS values should be modified from PxSCH N_{min PxSCH} to PxSCH N_{max PxSCH}”
   Accordingly, the N_{min PxSCH} and N_{max PxSCH} parameters may also be referred to as a first channel variable X and a last channel variable Y, where the value of the transmission/reception parameter is to be adapted across PxSCH between the Xth scheduled PxSCH and the Yth scheduled PxSCH.

In another embodiment, the set of RRC parameters contains at least a set of two parameters indicating two numerical values, Thₘᵢₙ≥1 and Thₘₐₓ≥Thₘᵢₙ. When compared against the value of the transmission/reception parameter for the x^{th} (x∈[1, N_{sched PxSCHs}]) PxSCH scheduled by the same DCI, these two parameters regulate if the modification of the value of the transmission/reception parameter is performed or not for the following PxSCHs.

Following the above example, the Thₘᵢₙ and Thₘₐₓ parameters could indicate that:
“MCS values are NOT modified if MCS_{xth PxSCH}<Thₘᵢₙ or MCS_{xth PxSCH}>Thₘₐₓ”

Accordingly, the Thₘᵢₙ and Thₘₐₓ parameters may also be referred to as a minimum parameter value variable THₘᵢₙ and a maximum parameter value variable THₘₐₓ, where the value of the transmission/reception parameter is to be adapted across multiple PxSCH, subjected to a constraint that the value of the transmission/reception parameter is not to fall below the minimum parameter value variable THₘᵢₙ and is not to exceed the maximum parameter value variable THₘₐₓ.

As an alternative, the condition above can be applied to the initial MCS only (MCS_{1st PxSCH}), signalled in DCI.

In another embodiment, the UE is configured (e.g., by RRC) with the pattern defining a parameter value or an offset to be applied to the value provided in DCI to modify transmission/reception parameter values. The pattern length should be equal to the number of PxSCHs allocated by one DCI. For example, if up to 4 PxSCHs can be allocated, there can be a pattern provided for each case:
2 PxSCHs→MCS offset pattern={0, −1}
3 PxSCHs→MCS offset pattern={0, −1, −2}
4 PxSCHs→MCS offset pattern={0, −2, −2, −2}
   In this Case, then, a DCI Message Scheduling N PxSCHs Indicates a Nominal Value for the Transmission/Reception Parameter, and RRC Signaling Indicates a Sequence of N Offset Values, where the Value of the Transmission/Reception Parameter for the Nth Scheduled PxSCH is to be Offset from the Nominal Value by the Nth Offset Value in the Indicated Sequence.

Alternatively, there can be one pattern provided for any number of PxSCHs scheduled by one DCI, and the UE can use only the first N values or offsets defined in the pattern.

In another embodiment, the pattern or any parameter above is configured as part of the Time Domain Resource Allocation (TDRA) table where a new column is added for this purpose. For example:

Example of TDRA table where MCS offset pattern is defined.

| | | Number of | MCS offset |
|---|---|---|---|
| Row index | . . . | PxSCHs | pattern |
| 1 | . . . | 2 | {0, −1} |
| 2 | . . . | 2 | {0, +1} |
| 3 | . . . | 2 | {0, +2} |
| 4 | . . . | 3 | {0, −1, −3} |
| . . . | . . . | | |

Existing DCI Content and/or New DCI Fields

In one embodiment, the modification of transmission/reception parameters for the PxSCHs scheduled by the same DCI is performed via the set of RRC parameters defined above and reusing existing DCI content (e.g., MCS and Frequency Domain Resource Allocation (FDRA) fields). The DCI content defines the parameters to use for the first PxSCH in the set of PxSCHs, and as the starting point for modifying the parameters for the following PxSCHs.

In another embodiment, the modification of transmission/reception parameter values for the PxSCHs scheduled by the same DCI is performed by adding new DCI fields, where one or a set of the parameters defined above are provided in these new DCI fields. The existing DCI content still defines the parameters to use for the first PxSCH in the set of PxSCHs, and as the starting point for modifying the parameter values for the following PxSCHs.

In another embodiment, if the modification of transmission/reception parameter values for the PxSCHs scheduled by a same DCI is performed via DCI extension, the UE may acknowledge DCI reception via dedicated Medium Access Control (MAC) Control Element (CE).

In another embodiment, independently on how the modification of transmission/reception parameter values for the PxSCHs scheduled by the same DCI is performed (e.g., RRC, DCI, and combinations), a new bit, B_{vers mPxSCH}, may be introduced in multi-PxSCH DCI so that the UE differentiates between multi-PxSCH DCI versions, e.g.:

$$\{ \begin{matrix}{B}_{vers mPxSCH} = 1 \to This is a multi - PxSCH DCI with modification of parameter values \\ {B}_{vers mPxSCH} = 0 \to This is a multi - PxSCH DCI with NO modification of parameter values\end{matrix}$$

In addition, this new bit value can point to the pre-configured pattern (reusing methods from previous section) which should be used for deriving transmission/reception parameter values. For example, if bit-field is 2-bit long, “00” signals that no parameter value modification is used, while values “01”, “10” and “11” point to one of the patterns.

In another embodiment, a new Radio Network Temporary Identifier (RNTI) is defined for multi-PxSCH scheduling with modification of transmission/reception parameter values (including MCS values and RB allocation).

In another embodiment, an identifier in DCI is defined, e.g., the identifier/indication can be included as a part of the FDRA field. If such indication is present, then DCI fields size (e.g., MCS bitfield) should be calculated assuming flexible/modified parameter values for the PxSCHs scheduled together. Otherwise, legacy allocation for single PxSCH or multiple PxSCHs with same transmission/reception parameter values apply.

In another embodiment, the DCI can be an activation DCI for Semi-Persistent Scheduling (SPS) or Configured Grant (CG, i.e., Type 2 CG, NR-U CG with cg-Retransmission Timer (CGRT) enabled/configured/disabled), which allocates multiple transport blocks (TBs) per period; therefore, the proposed enhancements would apply to SPS or CG for with multi-TB allocation in each period. For example, if an activation DCI allocates 8 TBs per SPS/CG period, then this DCI (possibly with the RRC configuration defined in the above embodiments) can provide flexible/modified parameter values as suggested in other embodiments, i.e., MCS values and RB allocation patterns for these 8 TBs in each period. Note that, once a pattern is configured, this pattern would apply in each period of SPS/CG multi-TB allocation. For example, if in the period X with 8 TBs, the first 4 TBs are transmitted with MCS P and last 4 TBs with MCS Q, then, in next period X+1, the first 4 TBs are again transmitted with MCS P and last 4 TBs with MCS Q, and so on. If flexible/modified parameter values are disabled, then all TBs per period, and also across different periods, will have similar parameter values for TBs, i.e., same MCS, same TB size, etc. The same concept can be applied to enhanced Type 1 CG based multi-TB allocation per period where a single CG allocating multiple TBs per period is activated using RRC parameters (with no need for activation DCI), and therefore, the flexible/modified parameter values for the TBs per period are indicated using RRC parameters suggested in the above embodiments.

Rules and/or Tables in Specification

In one embodiment, only a subset of the parameters defined above is explicitly signalled by the network, while there are default rules and values that apply for the parameters which are not explicitly signalled. Such default values are provided in a governing standardized specification via dedicated rules and tables.

### Pattern Selection

In some embodiments, one or more patterns are predefined and shared via RRC. Although the network may not know exactly how the channel state of a UE will change, the network may nonetheless predict or recognize trends in the UE's channel state (e.g., getting worse or better). In this case, the network may use a pattern that best matches the predicted or trending channel state of the UE, e.g., use a pattern that reduces MCSs over the scheduled PxSCHs if the predicted or trending channel state of the UE is getting worse.

In some embodiments, multiple patterns are defined (e.g., via RRC) and the network instructs the UE each time about which pattern to use (e.g., in each DCI via a dedicated bit).

### Examples of Use

Consider a few examples that show possible uses of the above embodiments.

### Example 1. Modification of MCS Values in Multi-PDSCH with Decremental Pattern 1

Assume that the following settings are provided by the network via RRC signaling:

| Parameter | Signalled value |
|---|---|
| Multi-PDSCH parameter to modify | “MCS” |
| Multi-PDSCH modification rule | “Decrement” |
| C_{2nd PDSCH} | 1 |
| N_{updt PDSCHs} | 1 |
| Thₘᵢₙ, Thₘₐₓ (MCS index thresholds in this case) | 10, 20 |

Moreover, the settings for the following parameters are not signalled; thus, default values provided in the standardized specification apply:

| Parameter | Default value |
|---|---|
| Δ_{C} | “NULL” → C_{xth PDSCH} = C_{2nd PDSCH}, |
| | ∀x (for all x) |
| N_{min PDSCH} and N_{max PDSCH} | 1, N_{sched PDSCHs} |

Upon reception of the above settings, the UE can infer and apply a specific pattern for modifying the MCS values for the PDSCHs scheduled in the incoming multi-PDSCH DCIs. For example, the UE receives the following multi-PDSCH DCIs and derives the following MCS modification pattern based on rules and parameters:

| DCI | Information from DCI | | | |
|---|---|---|---|---|
| # | N_{sched PDSCHs} | B_{vers mPDSCH} | MCS_{1st PDSCH} | MCS modification pattern |
| 1 | 5 | 1 | 15 | MCS_{1st PDSCH} = 15, MCS_{2nd PDSCH} = 14, |
| | | | | MCS_{3rd PDSCH} = 13, MCS_{4th PDSCH} = 12, |
| | | | | MCS_{5th PDSCH} = 11 |
| 2 | 2 | 1 | 19 | MCS_{1st PDSCH} = 19, MCS_{2nd PDSCH} = 18 |
| 3 | 4 | 1 | 8 | MCS_{1st PDSCH} = 8, MCS_{2nd PDSCH} = 8, |
| | | | | MCS_{3rd PDSCH} = 8, MCS_{4th PDSCH} = 8 |
| 4 | 4 | 1 | 25 | MCS_{1st PDSCH} = 25, MCS_{2nd PDSCH} = 25, |
| | | | | MCS_{3rd PDSCH} = 25, MCS_{4th PDSCH} = 25 |
| 5 | 3 | 0 | 15 | MCS_{1st PDSCH} = 15, MCS_{2nd PDSCH} = 15, |
| | | | | MCS_{3rd PDSCH} = 15 |

Note that the only parameter with modified values in multi-PDSCH is “MCS”, since no settings for modifying the value of other multi-PDSCH parameters (e.g., RBs) were signalled. And Multi-PUSCH with no parameter value modification is applied by the UE upon reception of multi-PUSCH DCIs, since no settings for multi-PUSCH modification were signalled.

### Example 2. Modification of MCS Values in Multi-PUSCH with Decremental Pattern 2

Assume that the following settings are provided by the network via RRC signaling: i

| Parameter | Signalled value |
|---|---|
| Multi-PUSCH parameter to modify | “MCS” |
| Multi-PUSCH modification rule | “Decrement” |
| C_{2nd PUSCH} | 1 |
| Δ_{C} | 1 |
| N_{updt PUSCHs} | 2 |
| N_{min PUSCH} and N_{max PUSCH} | 1, 6 |
| Thₘᵢₙ , Thₘₐₓ (MCS index thresholds in this case) | 10, 20 |

Upon reception of the above settings, the UE can infer and apply a specific pattern for modifying the MCS values for the PUSCHs scheduled in the incoming multi-PUSCH DCls. For example, the UE receives the following multi-PUSCH DCls and derive the following MCS modification patterns:

| DCI | Information from DCI | | | |
|---|---|---|---|---|
| # | N_{sched PUSCHs} | B_{vers mPUSCH} | MCS_{1st PUSCH} | MCS modification pattern |
| 1 | 4 | 1 | 19 | MCS_{1st PUSCH} = 19, MCS_{2nd PUSCH} = 19, |
| | | | | MCS_{3rd PUSCH} = 17, MCS_{4th PUSCH} = 17 |
| 2 | 8 | 1 | 19 | MCS_{1st PUSCH} = 19, MCS_{2nd PUSCH} = 19, |
| | | | | MCS_{3rd PUSCH} = 17, MCS_{4th PUSCH} = 17, |
| | | | | MCS_{5th PUSCH} = 13, MCS_{6th PUSCH} = 13, |
| | | | | MCS_{7th PUSCH} = 13, MCS_{8th PUSCH} = 13 |
| 3 | 5 | 1 | 3 | MCS_{1st PUSCH} = 3, MCS_{2nd PUSCH} = 3, |
| | | | | MCS_{3rd PUSCH} = 3, MCS_{4th PUSCH} = 3, |
| | | | | MCS_{5th PUSCH} = 3 |
| 4 | 2 | 1 | 23 | MCS_{1st PUSCH} = 23, MCS_{2nd PUSCH} = 23 |
| 5 | 4 | 0 | 19 | MCS_{1st PUSCH} = 19, MCS_{2nd PUSCH} = 19, |
| | | | | MCS_{3rd PUSCH} = 19, MCS_{4th PUSCH} = 19 |

Note that the only parameter with modified values in multi-PUSCH is “MCS”, since no settings for modifying the values of other multi-PUSCH parameters (e.g., RBs) were signalled. And Multi-PDSCH with no parameter value modification is applied by the UE upon reception of multi-PDSCH DCIs, since no settings for multi-PDSCH modification were signalled.

### Example 3. Modification of Type 1 RB Allocation in Multi-PUSCH with Decremental Pattern 3

Assume that the following settings are provided by the network via RRC signaling:

| Parameter | Signalled value |
|---|---|
| Multi-PUSCH parameter to modify | “RBs” |
| Multi-PUSCH modification rule | “Decrement” |
| C_{2nd PUSCH} | 1 |
| Δ_{C} | “NULL” |
| N_{updt PUSCHs} | 2 |
| N_{min PUSCH} and N_{max PUSCH} | 1, N_{sched PUSCHs} |
| Thₘᵢₙ, Thₘₐₓ (BW thresholds in this case) | 5 MHz, “NULL” |

Upon reception of the above settings, the UE can infer and apply a specific pattern for modifying the RB allocation for the PUSCHs scheduled in the incoming multi-PUSCH DCIs. For example, assume the UE receives the following multi-PUSCH DCIs, which provide Type 1 RB allocation, i.e., start position (S) and length (L) of the RB allocation are provided:

| DCI # | N_{sched PUSCHs} | B_{vers mPUSCH} | RB_{1st PUSCH} |
|---|---|---|---|
| 1 | 4 | 1 | [S = RB #0, L = 50 MHz] |
| 2 | 8 | 1 | [S = RB #0, L = 40 MHz] |
| 3 | 5 | 1 | [S = RB #0, L = 20 MHz] |
| 4 | 2 | 1 | [S = RB #0, L = 5 MHz] |
| 5 | 4 | 0 | [S = RB #0, L = 50 MHz] |

In this case, the C_{2nd PUSCH} parameter regulates how to modify the allocated RBs when considering a minimum “RB allocation step”. Assuming that the minimum RB allocation step is 5 MHz between 5 MHz to 30 MHz bandwidth (e.g., possible allocations are 5, 10, 15, 20, 25, and 30 MHz) and 10 MHz from 30 MHz to 100 MHz bandwidth (e.g., possible allocations are 30, 40, 50, 60, 70, 80, 90, and 100 MHz), the UE will apply the following patterns for modifying the RBs allocated for transmitting the PUSCHs in the above multi-PUSCH DCIs:

| DCI # | RB modification pattern |
|---|---|
| 1 | S: RB#0 for all PUSCHs |
| | L_{1st PUSCH} = 50 MHz, L_{2nd PUSCH} = 50 MHz, |
| | L_{3rd PUSCH} = 40 MHz, L_{4th PUSCH} = 40 MHz |
| 2 | S: RB#0 for all PUSCHs |
| | L_{1st PUSCH} = 40 MHz, L_{2nd PUSCH} = 40 MHz, |
| | L_{3rd PUSCH} = 30 MHz, L_{4th PUSCH} = 30 MHz, |
| | L_{5th PUSCH} = 25 MHz, L_{6th PUSCH} = 25 MHz, |
| | L_{7th PUSCH} = 20 MHz, L_{8th PUSCH} = 20 MHz |
| 3 | S: RB#0 for all PUSCHs |
| | L_{1st PUSCH} = 20 MHz, L_{2nd PUSCH} = 20 MHz, |
| | L_{3rd PUSCH} = 15 MHz, L_{4th PUSCH} = 15 MHz, |
| | L_{5th PUSCH} = 10 MHz |
| 4 | S: RB#0 for all PUSCHs |
| | L_{1st PUSCH} = 5 MHz, L_{2nd PUSCH} = 5 MHz |
| 5 | S: RB#0 for all PUSCHs |
| | L_{1st PUSCH} = 50 MHz, L_{2nd PUSCH} = 50 MHz, |
| | L_{3rd PUSCH} = 50 MHz, L_{4th PUSCH} = 50 MHz |

Note that, considering Type 1 RB allocation, the example shows that the UE modifies the RBs by maintaining the same start position (S) and reducing the RBs in order, starting from the rightmost RB, ultimately reducing the RB allocation length (L). Other ways to achieve the same modification can be used, e.g., shifting the start position (S) while maintaining the end position. The procedure(s) to adopt, also for other modification rules (e.g., “Increment”), may be provided in a governing standardized specification.

Further note that, in this example, the only parameter with modified values in multi-PUSCH is “RBs”, since no settings for modifying the values of other multi-PUSCH parameters (e.g., MCS) were signalled. And Multi-PDSCH with no parameter value modification is applied by the UE upon reception of multi-PDSCH DCIs, since no settings for multi-PDSCH modification were signalled.

### Example 4. Modification of Type 0 RB Allocation in Multi-PUSCH with Decremental Pattern 4

Assume that the same settings as per Example 3 are provided by the network via RRC signaling. Upon reception of the above settings, the UE can infer and apply a specific pattern for modifying the RB allocation for the PUSCHs scheduled in the incoming multi-PUSCH DCIs. For example, assume the UE receives the following multi-PUSCH DCIs providing Type 0 RB allocation, i.e., a bitmap for the RB allocation is provided:

| DCI # | N_{sched PUSCHs} | B_{vers mPUSCH} | RB_{1st PUSCH} |
|---|---|---|---|
| 1 | 4 | 1 | 11000011110000001111 |
| | | | L = 50 MHz |
| 2 | 8 | 1 | 11000011110000001100 |
| | | | L = 40 MHz |
| 3 | 5 | 1 | 00000011000000001100 |
| | | | L = 20 MHz |
| 4 | 2 | 1 | 10000000000000000000 |
| | | | L = 5 MHz |
| 5 | 4 | 0 | 11000011110000001111 |
| | | | L = 50 MHz |

Note that, just for illustrative purposes, the example used a 20-bit bitmap in the above table, where each bit represents a RBG of 5 MHz bandwidth (the actual bitmap length depends on bandwidth part (BWP) size and the configuration adopted to determine the RBG size for that BWP).

As for Example 3, the C_{2nd PUSCH} parameter regulates how to modify the allocated RBs when considering a minimum “RB allocation step” (also in this example, this step is 5 MHz for 5 MHz to 30 MHz bandwidth and 10 MHz for 30 MHz to 100 MHz bandwidth). The UE will apply the following patterns for modifying the RBs for transmitting the PUSCHs in the above multi-PUSCH DCIs:

| DCI # | RB modification pattern |
|---|---|
| 1 | 11000011110000001111 L_{1st PUSCH} = 50 MHz |
| | 11000011110000001111 L_{2nd PUSCH} = 50 MHz |
| | 11000011110000001100 L_{3rd PUSCH} = 40 MHz |
| | 11000011110000001100 L_{4th PUSCH} = 40 MHz |
| 2 | 11000011110000001100 L_{1st PUSCH} = 40 MHz |
| | 11000011110000001100 L_{2nd PUSCH} = 40 MHz |
| | 11000011110000000000 L_{3rd PUSCH} = 30 MHz |
| | 11000011110000000000 L_{4th PUSCH} = 30 MHz |
| | 11000011100000000000 L_{5th PUSCH} = 25 MHz |
| | 11000011100000000000 L_{6th PUSCH} = 25 MHz |
| | 11000011000000000000 L_{7th PUSCH} = 20 MHz |
| | 11000011000000000000 L_{8th PUSCH} = 20 MHz |
| 3 | 00000011000000001100 L_{1st PUSCH} = 20 MHz |
| | 00000011000000001100 L_{2nd PUSCH} = 20 MHz |
| | 00000011000000001000 L_{3rd PUSCH} = 15 MHz |
| | 00000011000000001000 L_{4th PUSCH} = 15 MHz |
| | 00000011000000000000 L_{5th PUSCH} = 10 MHz |
| 4 | 10000000000000000000 L_{1st PUSCH} = 5 MHz |
| | 10000000000000000000 L_{2nd PUSCH} = 5 MHz |
| 5 | 11000011110000001111 L_{1st PUSCH} = 50 MHz |
| | 11000011110000001111 L_{2nd PUSCH} = 50 MHz |
| | 11000011110000001111 L_{3rd PUSCH} = 50 MHz |
| | 11000011110000001111 L_{4th PUSCH} = 50 MHz |

Note that, considering Type 0 RB allocation, the example shows that the UE modifies the RBs by reducing the number of active RBGs (indicated by “1” in the bitmap) starting from the rightmost active RBG. Other ways to achieve the same modification can be used, e.g., reducing the number of active RBGs starting from the leftmost active RBG. The procedure(s) to adopt, also for other modification rules (e.g., “Increment”), may be provided in specification.

Further note that, in this example, the only parameter with modified values in multi-PUSCH is “RBs”, since no settings for modifying the values of other multi-PUSCH parameters (e.g., MCS) were signalled. And multi-PDSCH with no parameter value modification is applied by the UE upon reception of multi-PDSCH DCIs, since no settings for multi-PDSCH modification were signalled.

Some embodiments herein may be a part of radio access network (RAN) scheduling operations. As such, in case of 3GPP Rel-15 RAN splitting in Radio Units (RUs), Distributed Units (DUs), and Central Unit (CU), they may be implemented across DUs (e.g., hosted in edge nodes, co-located with the RUs) and CU (e.g., hosted in the cloud).

In particular, Layer 1 (L1) and Layer 2 (L2) operations (i.e., DCI messages) may be executed in the DUs, while Layer 3 (L3) operations (i.e., RRC messages) may be executed in the CU.

Alternatively or additionally, in case of an Open RAN (O-RAN) deployment, some embodiments may be implemented across O-RAN DUs (O-DUs) and O-RAN CU (O-CU) for L1/L2 and RRC operations, respectively. Note that, in the O-RAN architecture, O-DUs and O-CU interact with the O-RAN near-real-time RAN Intelligent Controller (near-RT RIC) component, which can be used for executing operations that may lead to further enhancing embodiments herein (e.g., traffic prediction, efficient multi-PxSCH activation, deactivation, reconfiguration, and so on).

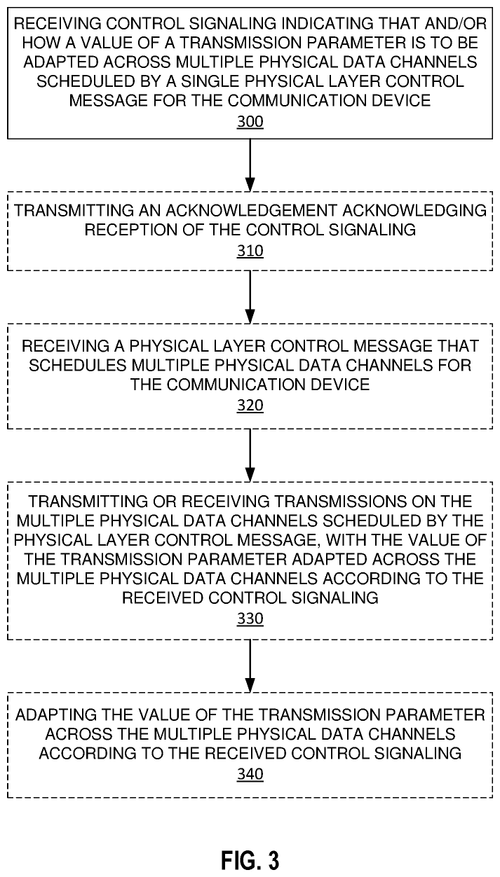

In view of the modifications and variations herein, FIG. 3 depicts a method performed by a communication device 12 in accordance with particular embodiments. The method includes receiving control signaling 22 indicating that and/or how a value of a transmission parameter P is to be adapted across multiple physical data channels 20 scheduled by a single physical layer control message 16 for the communication device 12 (Block 300).

In some embodiments, the method further includes transmitting an acknowledgement acknowledging reception of the control signaling 22 (Block 310).

In some embodiments, the method further includes receiving a physical layer control message 16 that schedules multiple physical data channels 20 for the communication device 12 (Block 320).

In some embodiments, the method further includes transmitting or receiving transmissions on the multiple physical data channels 20 scheduled by the physical layer control message 16, with the value of the transmission parameter P adapted across the multiple physical data channels 20 according to the received control signaling 22 (Block 330).

In some embodiments, the method further includes adapting the value of the transmission parameter P across the multiple physical data channels 20 according to the received control signaling 22 (Block 340).

In some embodiments, the control signaling 22 indicates the transmission parameter P whose value is to be adapted across multiple physical data channels 20 scheduled by a single physical layer control message 16 for the communication device 12.

In some embodiments, the control signaling 22 indicates a rule, formula, sequence, or pattern according to which the value of the transmission parameter P is to be adapted across multiple physical data channels 20 scheduled by a single physical layer control message 16 for the communication device 12. In some embodiments, according to the rule, formula, sequence, or pattern, the value of the transmission parameter P is to be incremented or decremented across multiple physical data channels 20 scheduled by a single physical layer control message 16 for the communication device 12. In some embodiments, the control signaling 22 explicitly indicates the rule, formula, sequence, or pattern. In other embodiments, the control signaling 22 implicitly indicates the rule, formula, sequence, or pattern by indicating an index mapped to the rule, formula, sequence, or pattern, with different possible indices being mapped to respective rules, formulas, sequences, or patterns. In some embodiments, the control signaling 22 implicitly indicates the rule, formula, sequence, or pattern by indicating an index mapped to the rule. In this case, the index mapped to the rule is an index into a time domain resource allocation table. In some embodiments, the single physical layer control message 16 indicates a nominal value for the parameter, and the control signaling 22 indicates a sequence of N offset values. In some embodiments, the value of the parameter for the Nth scheduled physical data channel is to be offset from the nominal value by the Nth offset value in the indicated sequence.

In some embodiments, the control signaling 22 indicates how often the value of the transmission parameter P is to be adapted across multiple physical data channels 20 scheduled by a single physical layer control message 16 for the communication device 12.

In some embodiments, the control signaling 22 indicates one or more respective values of one or more variables in a rule, formula, sequence, or pattern according to which the value of the transmission parameter P is to be adapted across multiple physical data channels 20 scheduled by a single physical layer control message 16 for the communication device 12. In some embodiments, the one or more variables include a delta variable. In this case, the value of the transmission parameter P is to be adapted by the value of the delta variable between successive ones of multiple physical data channels 20 scheduled by a single physical layer control message 16 for the communication device 12. In some embodiments, the single physical layer control message 16 indicates the value of the transmission parameter P for an earliest scheduled one of the multiple physical data channels 20, and the one or more variables include a first delta variable and a delta adaptation variable. In some embodiments, the value of the transmission parameter P is to be adapted by the value of the first delta variable between the earliest scheduled one of the multiple physical data channels 20 and a second earliest scheduled one of the multiple physical data channels 20. In some embodiments, the value of the transmission parameter P is to be adapted by the value of a second delta variable between successive ones of multiple physical data channels 20 after the second earliest scheduled one of the multiple physical data channels 20. In this case, the second delta variable is a function of the value of the delta adaptation variable. In some embodiments,

$${P}_{2 nd PDCH} = {P}_{1 st PDCH} - {C}_{2 nd PDCH}$$

$${C}_{xth PDCH} = {C}_{2 nd PDCH} * [ ( x - 1 ) * {Δ}_{C} ]$$

$${P}_{xth PDCH} = {P}_{( x - 1 ) th PDCH} - {C}_{xth PDCH}$$

where P_{1st PDCH} is the value of the parameter P for the earliest scheduled one of the multiple physical data channels 20, P_{2nd PDCH} is the value of the parameter P for the second earliest scheduled one of the multiple physical data channels 20, P_{xth PDCH} is the value of the parameter P for the xth scheduled one of the multiple physical data channels 20, C_{2nd PxSCH} is the first delta variable, Ac is the delta adaptation variable, and C_{xth PDCH} is the second delta variable. In some embodiments, the one or more variables include an adaptation frequency variable N. In this case, the value of the transmission parameter P is to be adapted every Nth successive one of multiple physical data channels 20 scheduled by a single physical layer control message 16 for the communication device 12. In some embodiments, the one or more variables include a first channel variable X and a last channel variable Y. In this case, the value of the transmission parameter P is to be adapted across physical data channels 20 between the Xth scheduled one of the multiple physical data channels 20 and the Yth scheduled one of the multiple physical data channels 20. In some embodiments, the one or more variables include a minimum parameter value variable THₘᵢₙ and a maximum parameter value variable THₘₐₓ. In this case, the value of the transmission parameter P is to be adapted across multiple physical data channels 20 scheduled by a single physical layer control message 16 for the communication device 12, subjected to a constraint that the value of the transmission parameter P is not to fall below the minimum parameter value variable THₘᵢₙ and is not to exceed the maximum parameter value variable THₘₐₓ.

In some embodiments, the single physical layer control message 16 includes a field indicating that, or whether, the value of the parameter is to be adapted across the multiple physical data channels 20 scheduled by the single physical layer control message 16.

In some embodiments, the single physical layer control message 16 is scrambled with a radio network temporary identifier that indicates the value of the parameter is to be adapted across the multiple physical data channels 20 scheduled by the single physical layer control message 16.

In some embodiments, the control signaling 22 includes radio resource control, RRC, signaling.

In some embodiments, at least a portion of the control signaling 22 is included in the single physical layer control message 16.

In some embodiments, the control signaling 22 includes a physical layer control message 16.

In some embodiments, the single physical layer control message 16 is a downlink control information, DCI, message.

In some embodiments, the parameter is a modulation and coding scheme, MCS, parameter.

In some embodiments, the parameter is a resource block, RB, allocation parameter.

In some embodiments, the parameter is a frequency domain resource allocation parameter.

In some embodiments, multiple physical data channels 20 scheduled by a single physical layer control message 16 comprise multiple physical data channels 20 scheduled in different time domain resources.

In some embodiments, multiple physical data channels 20 scheduled by a single physical layer control message 16 correspond to different respective time domain resource allocations indicated for the communication device 12 by the physical layer control message 16.

In some embodiments, the control signaling 22 indicates that and/or how a value of the parameter is to be adapted across multiple physical data channels 20 scheduled in one cell by a single physical layer control message 16 for the communication device 12.

In some embodiments, the multiple physical data channels 20 are multiple physical downlink data channels, multiple physical uplink data channels, or multiple physical sidelink data channels.

In some embodiments, the multiple physical data channels 20 are multiple Physical Downlink Shared Channels, PDSCH or multiple Physical Uplink Shared Channels, PUSCHs.

In some embodiments, the multiple physical data channels 20 carry extended reality, XR, application data.

In some embodiments, the control signaling 22 is received from a network node 14 in a communication network 10.

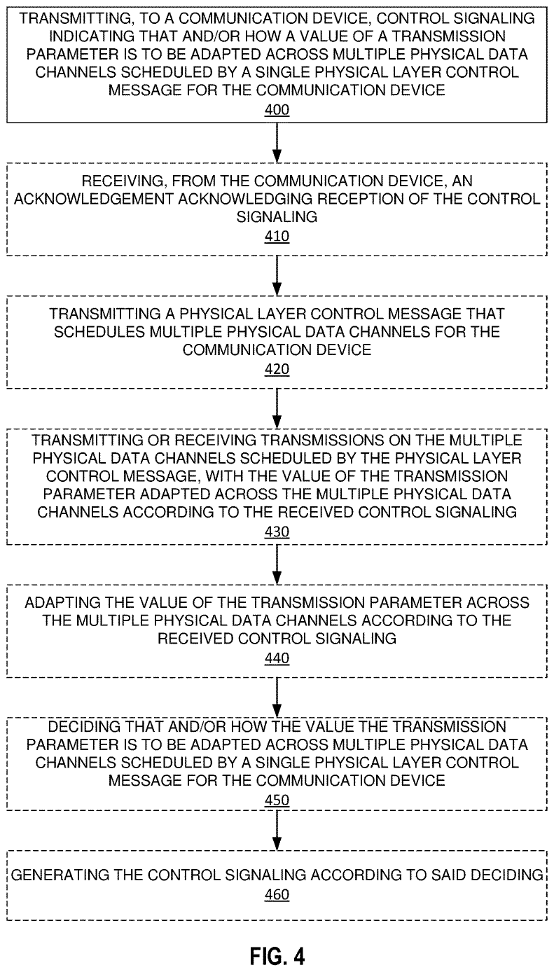

FIG. 4 depicts a method performed by a network node 14 in a communication network 10 in accordance with other particular embodiments. The method includes transmitting, to a communication device 12, control signaling 22 indicating that and/or how a value of a transmission parameter P is to be adapted across multiple physical data channels 20 scheduled by a single physical layer control message 16 for the communication device 12 (Block 400).

In some embodiments, the method further includes receiving, from the communication device 12, an acknowledgement acknowledging reception of the control signaling 22 (Block 410).

In some embodiments, the method further includes transmitting a physical layer control message 16 that schedules multiple physical data channels 20 for the communication device 12 (Block 420).

In some embodiments, the method further includes transmitting or receiving transmissions on the multiple physical data channels 20 scheduled by the physical layer control message 16, with the value of the transmission parameter P adapted across the multiple physical data channels 20 according to the received control signaling 22 (Block 430).

In some embodiments, the method further includes adapting the value of the transmission parameter P across the multiple physical data channels 20 according to the received control signaling 22 (Block 440).

In some embodiments, the method further includes deciding that and/or how the value the transmission parameter P is to be adapted across multiple physical data channels 20 scheduled by a single physical layer control message 16 for the communication device 12 (Block 450).

In some embodiments, the method further includes generating the control signaling 22 according to said deciding (Block 460).

In some embodiments, the control signaling 22 indicates the transmission parameter P whose value is to be adapted across multiple physical data channels 20 scheduled by a single physical layer control message 16 for the communication device 12.

In some embodiments, the control signaling 22 indicates a rule, formula, sequence, or pattern according to which the value of the transmission parameter P is to be adapted across multiple physical data channels 20 scheduled by a single physical layer control message 16 for the communication device 12. In some embodiments, according to the rule, formula, sequence, or pattern, the value of the transmission parameter P is to be incremented or decremented across multiple physical data channels 20 scheduled by a single physical layer control message 16 for the communication device 12. In some embodiments, the control signaling 22 explicitly indicates the rule, formula, sequence, or pattern. In other embodiments, the control signaling 22 implicitly indicates the rule, formula, sequence, or pattern by indicating an index mapped to the rule, formula, sequence, or pattern, with different possible indices being mapped to respective rules, formulas, sequences, or patterns. In some embodiments, the control signaling 22 implicitly indicates the rule, formula, sequence, or pattern by indicating an index mapped to the rule, wherein the index mapped to the rule is an index into a time domain resource allocation table. In some embodiments, the single physical layer control message 16 indicates a nominal value for the parameter, and the control signaling 22 indicates a sequence of N offset values. In this case, the value of the parameter for the Nth scheduled physical data channel is to be offset from the nominal value by the Nth offset value in the indicated sequence.

In some embodiments, the control signaling 22 indicates how often the value of the transmission parameter P is to be adapted across multiple physical data channels 20 scheduled by a single physical layer control message 16 for the communication device 12.

In some embodiments, the control signaling 22 indicates one or more respective values of one or more variables in a rule, formula, sequence, or pattern according to which the value of the transmission parameter P is to be adapted across multiple physical data channels 20 scheduled by a single physical layer control message 16 for the communication device 12. In some embodiments, the one or more variables include a delta variable. In this case, the value of the transmission parameter P is to be adapted by the value of the delta variable between successive ones of multiple physical data channels 20 scheduled by a single physical layer control message 16 for the communication device 12. In some embodiments, the single physical layer control message 16 indicates the value of the transmission parameter P for an earliest scheduled one of the multiple physical data channels 20, and the one or more variables include a first delta variable and a delta adaptation variable. In some embodiments, the value of the transmission parameter P is to be adapted by the value of the first delta variable between the earliest scheduled one of the multiple physical data channels 20 and a second earliest scheduled one of the multiple physical data channels 20. In some embodiments, the value of the transmission parameter P is to be adapted by the value of a second delta variable between successive ones of multiple physical data channels 20 after the second earliest scheduled one of the multiple physical data channels 20. In this case, the second delta variable is a function of the value of the delta adaptation variable. In some embodiments,

$${P}_{2 nd PDCH} = {P}_{1 st PDCH} - {C}_{2 nd PDCH}$$

$${C}_{xth PDCH} = {C}_{2 nd PDCH} * [ ( x - 1 ) * {Δ}_{C} ]$$

$${P}_{xth PDCH} = {P}_{( x - 1 ) th PDCH} - {C}_{xth PDCH}$$

where P_{1st PDCH} is the value of the parameter P for the earliest scheduled one of the multiple physical data channels 20, P_{2nd PDCH} is the value of the parameter P for the second earliest scheduled one of the multiple physical data channels 20, P_{xth PDCH} is the value of the parameter P for the xth scheduled one of the multiple physical data channels 20, C_{2nd PxSCH} is the first delta variable, Ac is the delta adaptation variable, and C_{xth PDCH} is the second delta variable. In some embodiments, the one or more variables include an adaptation frequency variable N. In this case, the value of the transmission parameter P is to be adapted every Nth successive one of multiple physical data channels 20 scheduled by a single physical layer control message 16 for the communication device 12. In some embodiments, the one or more variables include a first channel variable X and a last channel variable Y. In this case, the value of the transmission parameter P is to be adapted across physical data channels 20 between the Xth scheduled one of the multiple physical data channels 20 and the Yth scheduled one of the multiple physical data channels 20. In some embodiments, the one or more variables include a minimum parameter value variable THₘᵢₙ and a maximum parameter value variable THₘₐₓ. In this case, the value of the transmission parameter P is to be adapted across multiple physical data channels 20 scheduled by a single physical layer control message 16 for the communication device 12, subjected to a constraint that the value of the transmission parameter P is not to fall below the minimum parameter value variable THₘᵢₙ and is not to exceed the maximum parameter value variable THₘₐₓ.

In some embodiments, the single physical layer control message 16 includes a field indicating that, or whether, the value of the parameter is to be adapted across the multiple physical data channels 20 scheduled by the single physical layer control message 16.

In some embodiments, the single physical layer control message 16 is scrambled with a radio network temporary identifier that indicates the value of the parameter is to be adapted across the multiple physical data channels 20 scheduled by the single physical layer control message 16.

In some embodiments, the control signaling 22 includes radio resource control, RRC, signaling.

In some embodiments, at least a portion of the control signaling 22 is included in the single physical layer control message 16.

In some embodiments, the control signaling 22 includes a physical layer control message 16.

In some embodiments, the single physical layer control message 16 is a downlink control information, DCI, message.

In some embodiments, the parameter is a resource block, RB, allocation parameter.

In some embodiments, the parameter is a frequency domain resource allocation parameter.

In some embodiments, multiple physical data channels 20 scheduled by a single physical layer control message 16 comprise multiple physical data channels 20 scheduled in different time domain resources.

In some embodiments, multiple physical data channels 20 scheduled by a single physical layer control message 16 correspond to different respective time domain resource allocations indicated for the communication device 12 by the physical layer control message 16.

In some embodiments, the control signaling 22 indicates that and/or how a value of the parameter is to be adapted across multiple physical data channels 20 scheduled in one cell by a single physical layer control message 16 for the communication device 12.

In some embodiments, the multiple physical data channels 20 are multiple physical downlink data channels, multiple physical uplink data channels, or multiple physical sidelink data channels.

In some embodiments, the multiple physical data channels 20 are multiple Physical Downlink Shared Channels, PDSCH or multiple Physical Uplink Shared Channels, PUSCHs.

In some embodiments, the multiple physical data channels 20 carry extended reality, XR, application data.

Embodiments herein also include corresponding apparatuses. Embodiments herein for instance include a communication device 12 configured to perform any of the steps of any of the embodiments described above for the communication device 12.

Embodiments also include a communication device 12 comprising processing circuitry and power supply circuitry. The processing circuitry is configured to perform any of the steps of any of the embodiments described above for the communication device 12. The power supply circuitry is configured to supply power to the communication device 12.

Embodiments further include a communication device 12 comprising processing circuitry. The processing circuitry is configured to perform any of the steps of any of the embodiments described above for the communication device 12. In some embodiments, the communication device 12 further comprises communication circuitry.

Embodiments further include a communication device 12 comprising processing circuitry and memory. The memory contains instructions executable by the processing circuitry whereby the communication device 12 is configured to perform any of the steps of any of the embodiments described above for the communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 14 configured to perform any of the steps of any of the embodiments described above for the network node 14.

Embodiments also include a network node 14 comprising processing circuitry and power supply circuitry. The processing circuitry is configured to perform any of the steps of any of the embodiments described above for the network node 14. The power supply circuitry is configured to supply power to the network node 14.

Embodiments further include a network node 14 comprising processing circuitry. The processing circuitry is configured to perform any of the steps of any of the embodiments described above for the network node 14. In some embodiments, the network node 14 further comprises communication circuitry.

Embodiments further include a network node 14 comprising processing circuitry and memory. The memory contains instructions executable by the processing circuitry whereby the network node 14 is configured to perform any of the steps of any of the embodiments described above for the network node 14.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

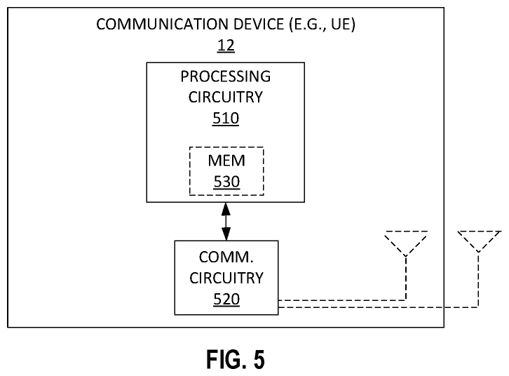

FIG. 5 for example illustrates a communication device 12 as implemented in accordance with one or more embodiments. As shown, the communication device 12 includes processing circuitry 510 and communication circuitry 520. The communication circuitry 520 (e.g., radio circuitry) is configured to transmit and/or receive information to and/or from one or more other nodes, e.g., via any communication technology. Such communication may occur via one or more antennas that are either internal or external to the communication device 12. The processing circuitry 510 is configured to perform processing described above, e.g., in FIG. 3, such as by executing instructions stored in memory 530. The processing circuitry 510 in this regard may implement certain functional means, units, or modules.

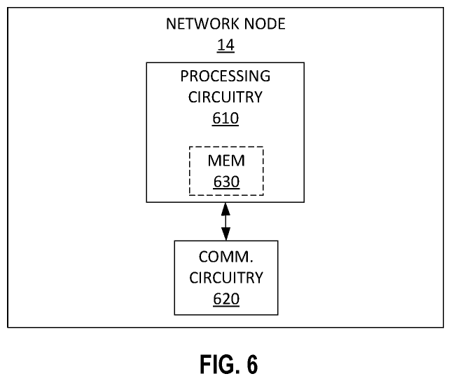

FIG. 6 illustrates a network node 14 as implemented in accordance with one or more embodiments. As shown, the network node 14 includes processing circuitry 610 and communication circuitry 620. The communication circuitry 620 is configured to transmit and/or receive information to and/or from one or more other nodes, e.g., via any communication technology. The processing circuitry 610 is configured to perform processing described above, e.g., in FIG. 4, such as by executing instructions stored in memory 630. The processing circuitry 610 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

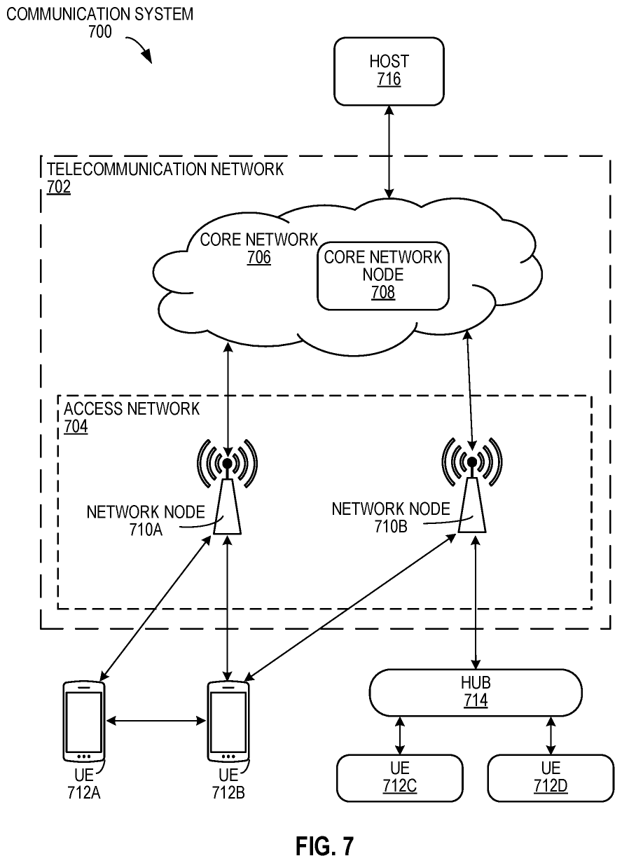

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3^{rd} Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

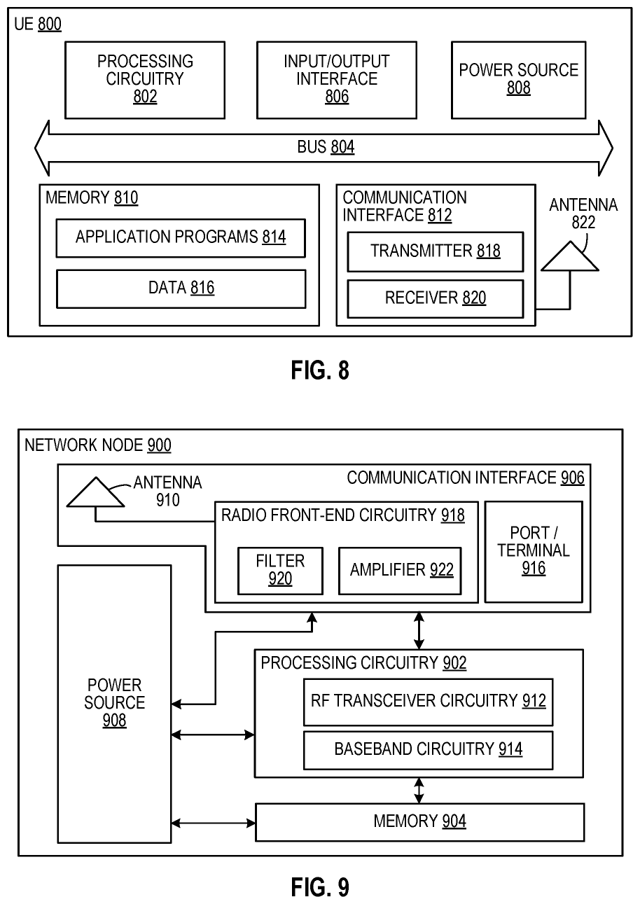

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

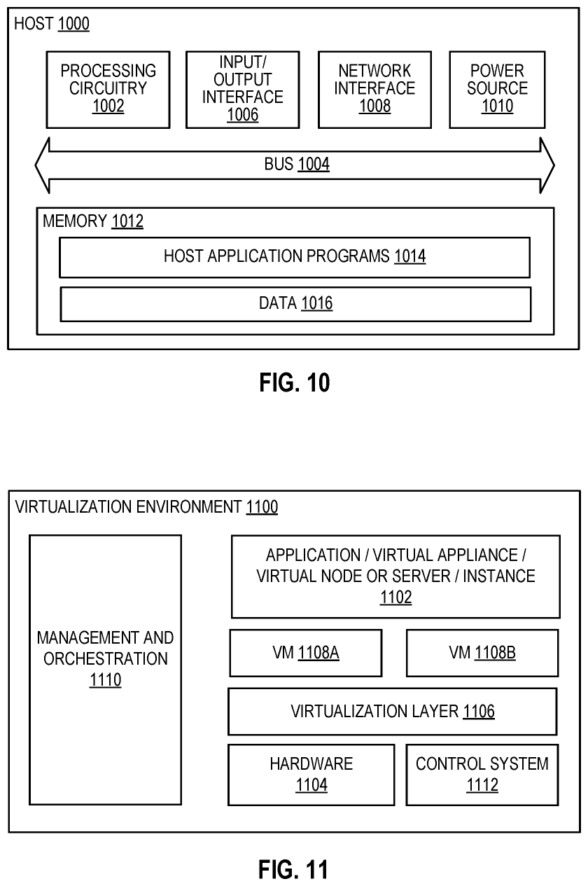

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

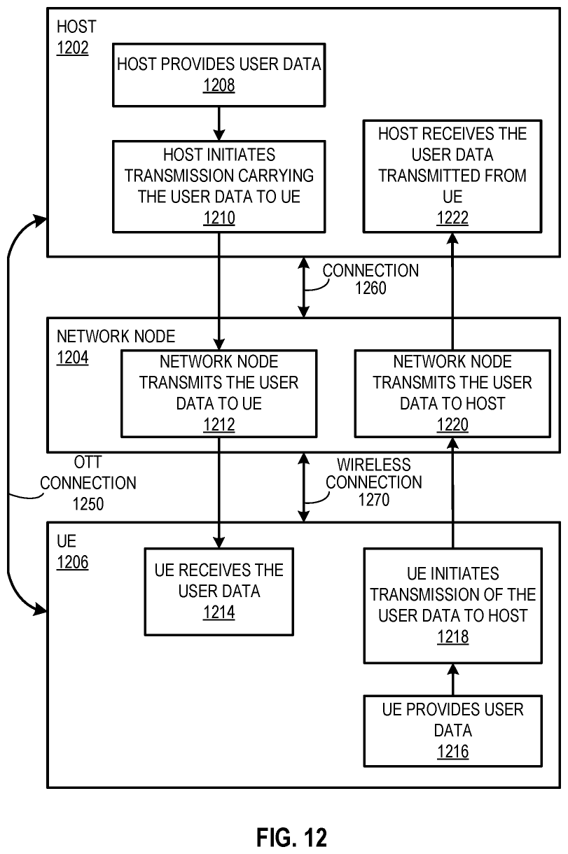

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example embodiments of the techniques and apparatus described herein include, but are not limited to, the following enumerated examples:

### Group A Embodiments

A1. A method performed by a communication device, the method comprising:
   receiving control signaling indicating that and/or how a value of a transmission parameter is to be adapted across multiple physical data channels scheduled by a single physical layer control message for the communication device.
A2. The method of embodiment A1, wherein the control signaling indicates the transmission parameter whose value is to be adapted across multiple physical data channels scheduled by a single physical layer control message for the communication device.
A3. The method of any of embodiments A1-A2, wherein the control signaling indicates a rule, formula, sequence, or pattern according to which the value of the transmission parameter is to be adapted across multiple physical data channels scheduled by a single physical layer control message for the communication device.
A4. The method of embodiment A3, wherein, according to the rule, formula, sequence, or pattern, the value of the transmission parameter is to be incremented or decremented across multiple physical data channels scheduled by a single physical layer control message for the communication device.
A5. The method of any of embodiments A3-A4, wherein the control signaling:
   explicitly indicates the rule, formula, sequence, or pattern; or
   implicitly indicates the rule, formula, sequence, or pattern by indicating an index mapped to the rule, formula, sequence, or pattern, with different possible indices being mapped to respective rules, formulas, sequences, or patterns.
A6. The method of embodiment A5, wherein the control signaling implicitly indicates the rule, formula, sequence, or pattern by indicating an index mapped to the rule, wherein the index mapped to the rule is an index into a time domain resource allocation table.
A7. The method of any of embodiments A3-A6, wherein the single physical layer control message indicates a nominal value for the parameter, and wherein the control signaling indicates a sequence of N offset values, wherein the value of the parameter for the Nth scheduled physical data channel is to be offset from the nominal value by the Nth offset value in the indicated sequence.
A8. The method of any of embodiments A1-A7, wherein the control signaling indicates how often the value of the transmission parameter is to be adapted across multiple physical data channels scheduled by a single physical layer control message for the communication device.
A9. The method of any of embodiments A1-A8, wherein the control signaling indicates one or more respective values of one or more variables in a rule, formula, sequence, or pattern according to which the value of the transmission parameter is to be adapted across multiple physical data channels scheduled by a single physical layer control message for the communication device.
A10. The method of embodiment A9, wherein the one or more variables include a delta variable, wherein the value of the transmission parameter is to be adapted by the value of the delta variable between successive ones of multiple physical data channels scheduled by a single physical layer control message for the communication device.
A11. The method of embodiment A9, wherein the single physical layer control message indicates the value of the transmission parameter for an earliest scheduled one of the multiple physical data channels, and wherein the one or more variables include a first delta variable and a delta adaptation variable, wherein:
   the value of the transmission parameter is to be adapted by the value of the first delta variable between the earliest scheduled one of the multiple physical data channels and a second earliest scheduled one of the multiple physical data channels; and
   the value of the transmission parameter is to be adapted by the value of a second delta variable between successive ones of multiple physical data channels after the second earliest scheduled one of the multiple physical data channels, wherein the second delta variable is a function of the value of the delta adaptation variable.
A12. The method of embodiment A11, wherein:

$${P}_{2 nd PDCH} = {P}_{1 st PDCH} - {C}_{2 nd PDCH}$$

$${C}_{xth PDCH} = {C}_{2 nd PDCH} * [ ( x - 1 ) * {Δ}_{C} ]$$

$${P}_{xth PDCH} = {P}_{( x - 1 ) th PDCH} - {C}_{xth PDCH}$$

where P_{1st PDCH} is the value of the parameter P for the earliest scheduled one of the multiple physical data channels, P_{2nd PDCH} is the value of the parameter P for the second earliest scheduled one of the multiple physical data channels, P_{xth PDCH} is the value of the parameter P for the xth scheduled one of the multiple physical data channels, C_{2nd PxSCH} is the first delta variable, Ac is the delta adaptation variable, and C_{xth PDCH} is the second delta variable.
A13. The method of any of embodiments A9-A12, wherein the one or more variables include a adaptation frequency variable N, wherein the value of the transmission parameter is to be adapted every Nth successive one of multiple physical data channels scheduled by a single physical layer control message for the communication device.
A14. The method of any of embodiments A9-A13, wherein the one or more variables include a first channel variable X and a last channel variable Y, wherein the value of the transmission parameter is to be adapted across physical data channels between the Xth scheduled one of the multiple physical data channels and the Yth scheduled one of the multiple physical data channels.
A15. The method of any of embodiments A9-A14, wherein the one or more variables include a minimum parameter value variable THₘᵢₙ and a maximum parameter value variable THₘₐₓ, wherein the value of the transmission parameter is to be adapted across multiple physical data channels scheduled by a single physical layer control message for the communication device, subjected to a constraint that the value of the transmission parameter is not to fall below the minimum parameter value variable THₘᵢₙ and is not to exceed the maximum parameter value variable THₘₐₓ.
A16. The method of any of embodiments A1-A15, wherein the single physical layer control message includes a field indicating that, or whether, the value of the parameter is to be adapted across the multiple physical data channels scheduled by the single physical layer control message.
A17. The method of any of embodiments A1-A15, wherein the single physical layer control message is scrambled with a radio network temporary identifier that indicates the value of the parameter is to be adapted across the multiple physical data channels scheduled by the single physical layer control message.
A18. The method of any of embodiments A1-A17, wherein the control signaling includes radio resource control, RRC, signaling.
A19. The method of any of embodiments A1-A18, wherein at least a portion of the control signaling is included in the single physical layer control message.
A20. The method of any of embodiments A1-A19, wherein the control signaling includes a physical layer control message.
A21. The method of any of embodiments A1-A20, wherein the single physical layer control message is a downlink control information, DCI, message.
A22. The method of any of embodiments A1-A21, wherein the parameter is a modulation and coding scheme, MCS, parameter.
A23. The method of any of embodiments A1-A21, wherein the parameter is a resource block, RB, allocation parameter.
A24. The method of any of embodiments A1-A21, wherein the parameter is a frequency domain resource allocation parameter.
A25. The method of any of embodiments A1-A24, wherein multiple physical data channels scheduled by a single physical layer control message comprise multiple physical data channels scheduled in different time domain resources.
A26. The method of any of embodiments A1-A25, wherein multiple physical data channels scheduled by a single physical layer control message correspond to different respective time domain resource allocations indicated for the communication device by the physical layer control message.
A27. The method of any of embodiments A1-A26, wherein the control signaling indicates that and/or how a value of the parameter is to be adapted across multiple physical data channels scheduled in one cell by a single physical layer control message for the communication device.
A28. The method of any of embodiments A1-A27, wherein the multiple physical data channels are multiple physical downlink data channels, multiple physical uplink data channels, or multiple physical sidelink data channels.
A29. The method of any of embodiments A1-A28, wherein the multiple physical data channels are multiple Physical Downlink Shared Channels, PDSCH or multiple Physical Uplink Shared Channels, PUSCHs.
A30. The method of any of embodiments A1-A29, wherein the multiple physical data channels carry extended reality, XR, application data.
A31. The method of any of embodiments A1-A30, further comprising transmitting an acknowledgement acknowledging reception of the control signaling.
A32. The method of embodiment A31, wherein the acknowledgement is included in a medium access control, MAC, control element, CE.
A33. The method of any of embodiments A1-A32, further comprising:
   receiving a physical layer control message that schedules multiple physical data channels for the communication device; and
   transmitting or receiving transmissions on the multiple physical data channels scheduled by the physical layer control message, with the value of the transmission parameter adapted across the multiple physical data channels according to the received control signaling.
A34. The method of embodiment A33, further comprising adapting the value of the transmission parameter across the multiple physical data channels according to the received control signaling.
A35. The method of any of embodiments A1-A34, wherein the control signaling is received from a network node in a communication network.
A36. The method of any of embodiments A1-A35, wherein multiple transport blocks, TBs, correspond to the multiple physical data channels such that the single physical layer control message schedules multiple TBs.
A37. The method of embodiment A36, wherein the single physical layer control message schedules multiple TBs per Semi-Persistent Scheduling (SPS) period or Configured Grant (CG) period.
AA. The method of any of the previous embodiments, further comprising:
   providing user data; and
   forwarding the user data to a host computer via the transmission to a base station.

### Group B Embodiments

B1. A method performed by a network node in a communication network, the method comprising:
   transmitting, to a communication device, control signaling indicating that and/or how a value of a transmission parameter is to be adapted across multiple physical data channels scheduled by a single physical layer control message for the communication device.
B2. The method of embodiment B1, wherein the control signaling indicates the transmission parameter whose value is to be adapted across multiple physical data channels scheduled by a single physical layer control message for the communication device.
B3. The method of any of embodiments B1-B2, wherein the control signaling indicates a rule, formula, sequence, or pattern according to which the value of the transmission parameter is to be adapted across multiple physical data channels scheduled by a single physical layer control message for the communication device.
B4. The method of embodiment B3, wherein, according to the rule, formula, sequence, or pattern, the value of the transmission parameter is to be incremented or decremented across multiple physical data channels scheduled by a single physical layer control message for the communication device.
B5. The method of any of embodiments B3-B4, wherein the control signaling:
   explicitly indicates the rule, formula, sequence, or pattern; or
   implicitly indicates the rule, formula, sequence, or pattern by indicating an index mapped to the rule, formula, sequence, or pattern, with different possible indices being mapped to respective rules, formulas, sequences, or patterns.
B6. The method of embodiment B5, wherein the control signaling implicitly indicates the rule, formula, sequence, or pattern by indicating an index mapped to the rule, wherein the index mapped to the rule is an index into a time domain resource allocation table.
B7. The method of any of embodiments B3-B6, wherein the single physical layer control message indicates a nominal value for the parameter, and wherein the control signaling indicates a sequence of N offset values, wherein the value of the parameter for the Nth scheduled physical data channel is to be offset from the nominal value by the Nth offset value in the indicated sequence.
B8. The method of any of embodiments B1-B7, wherein the control signaling indicates how often the value of the transmission parameter is to be adapted across multiple physical data channels scheduled by a single physical layer control message for the communication device.
B9. The method of any of embodiments B1-B8, wherein the control signaling indicates one or more respective values of one or more variables in a rule, formula, sequence, or pattern according to which the value of the transmission parameter is to be adapted across multiple physical data channels scheduled by a single physical layer control message for the communication device.
B10. The method of embodiment B9, wherein the one or more variables include a delta variable, wherein the value of the transmission parameter is to be adapted by the value of the delta variable between successive ones of multiple physical data channels scheduled by a single physical layer control message for the communication device.
B11. The method of embodiment B9, wherein the single physical layer control message indicates the value of the transmission parameter for an earliest scheduled one of the multiple physical data channels, and wherein the one or more variables include a first delta variable and a delta adaptation variable, wherein:
   the value of the transmission parameter is to be adapted by the value of the first delta variable between the earliest scheduled one of the multiple physical data channels and a second earliest scheduled one of the multiple physical data channels; and
   the value of the transmission parameter is to be adapted by the value of a second delta variable between successive ones of multiple physical data channels after the second earliest scheduled one of the multiple physical data channels, wherein the second delta variable is a function of the value of the delta adaptation variable.
B12. The method of embodiment B11, wherein:

$${P}_{2 nd PDCH} = {P}_{1 st PDCH} - {C}_{2 nd PDCH}$$

$${C}_{xth PDCH} = {C}_{2 nd PDCH} * [ ( x - 1 ) * {Δ}_{C} ]$$

$${P}_{xth PDCH} = {P}_{( x - 1 ) th PDCH} - {C}_{xth PDCH}$$

where P_{1st PDCH} is the value of the parameter P for the earliest scheduled one of the multiple physical data channels, P_{2nd PDCH} is the value of the parameter P for the second earliest scheduled one of the multiple physical data channels, P_{xth PDCH} is the value of the parameter P for the xth scheduled one of the multiple physical data channels, C_{2nd PxSCH} is the first delta variable, Ac is the delta adaptation variable, and C_{xth PDCH} is the second delta variable.
B13. The method of any of embodiments B9-B12, wherein the one or more variables include a adaptation frequency variable N, wherein the value of the transmission parameter is to be adapted every Nth successive one of multiple physical data channels scheduled by a single physical layer control message for the communication device.
B14. The method of any of embodiments B9-B13, wherein the one or more variables include a first channel variable X and a last channel variable Y, wherein the value of the transmission parameter is to be adapted across physical data channels between the Xth scheduled one of the multiple physical data channels and the Yth scheduled one of the multiple physical data channels.
B15. The method of any of embodiments B9-B14, wherein the one or more variables include a minimum parameter value variable THₘᵢₙ and a maximum parameter value variable THₘₐₓ, wherein the value of the transmission parameter is to be adapted across multiple physical data channels scheduled by a single physical layer control message for the communication device, subjected to a constraint that the value of the transmission parameter is not to fall below the minimum parameter value variable THₘᵢₙ and is not to exceed the maximum parameter value variable THₘₐₓ.
B16. The method of any of embodiments B1-B15, wherein the single physical layer control message includes a field indicating that, or whether, the value of the parameter is to be adapted across the multiple physical data channels scheduled by the single physical layer control message.
B17. The method of any of embodiments B1-B15, wherein the single physical layer control message is scrambled with a radio network temporary identifier that indicates the value of the parameter is to be adapted across the multiple physical data channels scheduled by the single physical layer control message.
B18. The method of any of embodiments B1-B17, wherein the control signaling includes radio resource control, RRC, signaling.
B19. The method of any of embodiments B1-B18, wherein at least a portion of the control signaling is included in the single physical layer control message.
B20. The method of any of embodiments B1-B19, wherein the control signaling includes a physical layer control message.
B21. The method of any of embodiments B1-B20, wherein the single physical layer control message is a downlink control information, DCI, message.
B22. The method of any of embodiments B1-B21, wherein the parameter is a modulation and coding scheme, MCS, parameter.
B23. The method of any of embodiments B1-B21, wherein the parameter is a resource block, RB, allocation parameter.
B24. The method of any of embodiments B1-B21, wherein the parameter is a frequency domain resource allocation parameter.
B25. The method of any of embodiments B1-B24, wherein multiple physical data channels scheduled by a single physical layer control message comprise multiple physical data channels scheduled in different time domain resources.
B26. The method of any of embodiments B1-B25, wherein multiple physical data channels scheduled by a single physical layer control message correspond to different respective time domain resource allocations indicated for the communication device by the physical layer control message.
B27. The method of any of embodiments B1-B26, wherein the control signaling indicates that and/or how a value of the parameter is to be adapted across multiple physical data channels scheduled in one cell by a single physical layer control message for the communication device B28. The method of any of embodiments B1-B27, wherein the multiple physical data channels are multiple physical downlink data channels, multiple physical uplink data channels, or multiple physical sidelink data channels.
B29. The method of any of embodiments B1-B28, wherein the multiple physical data channels are multiple Physical Downlink Shared Channels, PDSCH or multiple Physical Uplink Shared Channels, PUSCHs.
B30. The method of any of embodiments B1-B29, wherein the multiple physical data channels carry extended reality, XR, application data.
B31. The method of any of embodiments B1-B30, further comprising receiving, from the communication device, an acknowledgement acknowledging reception of the control signaling.
B32. The method of embodiment B31, wherein the acknowledgement is included in a medium access control, MAC, control element, CE.
B33. The method of any of embodiments B1-A32, further comprising:
   transmitting a physical layer control message that schedules multiple physical data channels for the communication device; and
   transmitting or receiving transmissions on the multiple physical data channels scheduled by the physical layer control message, with the value of the transmission parameter adapted across the multiple physical data channels according to the transmitted control signaling.
B34. The method of embodiment B33, further comprising adapting the value of the transmission parameter across the multiple physical data channels according to the received control signaling.
B35. The method of any of embodiments B1-B33, further comprising:
   deciding that and/or how the value the transmission parameter is to be adapted across multiple physical data channels scheduled by a single physical layer control message for the communication device; and
   generating the control signaling according to said deciding.
BB. The method of any of the previous embodiments, further comprising:
   obtaining user data; and
   forwarding the user data to a host computer or a communication device.

### Group C Embodiments

C1. A communication device configured to perform any of the steps of any of the Group A embodiments.
C2. A communication device comprising processing circuitry configured to perform any of the steps of any of the Group A embodiments.
C3. A communication device comprising:
   communication circuitry; and
   processing circuitry configured to perform any of the steps of any of the Group A embodiments.
C4. A communication device comprising:
   processing circuitry configured to perform any of the steps of any of the Group A embodiments; and
   power supply circuitry configured to supply power to the communication device.
C5. A communication device comprising:
   processing circuitry and memory, the memory containing instructions executable by the processing circuitry whereby the communication device is configured to perform any of the steps of any of the Group A embodiments.
C6. The communication device of any of embodiments C1-C5, wherein the communication device is a wireless communication device.
C7. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
C8. A computer program comprising instructions which, when executed by at least one processor of a communication device, causes the communication device to carry out the steps of any of the Group A embodiments.
C9. A carrier containing the computer program of embodiment C7, wherein the carrier is one of an electronic signal, optical signal, radio signal, or computer readable storage medium.
C10. A network node configured to perform any of the steps of any of the Group B embodiments.
C11. A network node comprising processing circuitry configured to perform any of the steps of any of the Group B embodiments.
C12. A network node comprising:
   communication circuitry; and
   processing circuitry configured to perform any of the steps of any of the Group B embodiments.
C13. A network node comprising:
   processing circuitry configured to perform any of the steps of any of the Group B embodiments;
   power supply circuitry configured to supply power to the network node.
C14. A network node comprising:
   processing circuitry and memory, the memory containing instructions executable by the processing circuitry whereby the network node is configured to perform any of the steps of any of the Group B embodiments.
C15. The network node of any of embodiments C10-C14, wherein the network node is a base station.
C16. A computer program comprising instructions which, when executed by at least one processor of a network node, causes the network node to carry out the steps of any of the Group B embodiments.
C17. The computer program of embodiment C16, wherein the network node is a base station.
C18. A carrier containing the computer program of any of embodiments C16-C17, wherein the carrier is one of an electronic signal, optical signal, radio signal, or computer readable storage medium.

### Group D Embodiments

D1. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
D2. The communication system of the previous embodiment further including the base station.
D3. The communication system of the previous 2 embodiments, further including the UE, wherein the UE is configured to communicate with the base station.
D4. The communication system of the previous 3 embodiments, wherein:
   the processing circuitry of the host computer is configured to execute a host application, thereby providing the user data; and
   the UE comprises processing circuitry configured to execute a client application associated with the host application.
D5. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
D6. The method of the previous embodiment, further comprising, at the base station, transmitting the user data.
D7. The method of the previous 2 embodiments, wherein the user data is provided at the host computer by executing a host application, the method further comprising, at the UE, executing a client application associated with the host application.
D8. A user equipment (UE) configured to communicate with a base station, the UE comprising a radio interface and processing circuitry configured to perform any of the previous 3 embodiments.
D9. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
D10. The communication system of the previous embodiment, wherein the cellular network further includes a base station configured to communicate with the UE.
D11. The communication system of the previous 2 embodiments, wherein:
   the processing circuitry of the host computer is configured to execute a host application, thereby providing the user data; and
   the UE's processing circuitry is configured to execute a client application associated with the host application.
D12. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
D13. The method of the previous embodiment, further comprising at the UE, receiving the user data from the base station.
D14. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
D15. The communication system of the previous embodiment, further including the UE.
D16. The communication system of the previous 2 embodiments, further including the base station, wherein the base station comprises a radio interface configured to communicate with the UE and a communication interface configured to forward to the host computer the user data carried by a transmission from the UE to the base station.
D17. The communication system of the previous 3 embodiments, wherein:
   the processing circuitry of the host computer is configured to execute a host application; and
   the UE's processing circuitry is configured to execute a client application associated with the host application, thereby providing the user data.
D18. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
D19. A method implemented in a communication system including a host computer, a base station and a user equipment (UE), the method comprising:
   at the host computer, receiving user data transmitted to the base station from the UE, wherein the UE performs any of the steps of any of the Group A embodiments.
D20. The method of the previous embodiment, further comprising, at the UE, providing the user data to the base station.
D21. The method of the previous 2 embodiments, further comprising:
   at the UE, executing a client application, thereby providing the user data to be transmitted; and
   at the host computer, executing a host application associated with the client application.
D22. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
D24. The communication system of the previous embodiment further including the base station.
D25. The communication system of the previous 2 embodiments, further including the UE, wherein the UE is configured to communicate with the base station.
D26. The communication system of the previous 3 embodiments, wherein:
   the processing circuitry of the host computer is configured to execute a host application;
   the UE is configured to execute a client application associated with the host application, thereby providing the user data to be received by the host computer.
D27. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
D28. The method of the previous embodiment, further comprising at the base station, receiving the user data from the UE.
D29. The method of the previous 2 embodiments, further comprising at the base station, initiating a transmission of the received user data to the host computer.

### REFERENCES

1. E. Dahlman, S. Parkvall, J. Sköld, “5G NR—The Next Generation Wireless Access Technology,” 2^{nd} Edition, Academic Press, 2021.
2. F. Alriksson et al. “Ericsson Technology Review—XR and 5G: Extended reality at scale with time-critical communication”, Available Online, Accessed on January 2022, 2021.
3. 3GPP TR 38.838 “Study on XR (Extended Reality) Evaluations for NR”, V17.0.0, December 2021.
4. 3GPP TSG RAN WG1 #109-e RAN1 Chair's Notes, May 9th-20th, 2022.

1.-35. (canceled)

36. A method performed by a communication device, the method comprising:
receiving radio resource control (RRC) signaling indicating how a value of a transmission parameter is to be adapted across multiple physical data channels scheduled by a single physical layer control message for the communication device;
receiving a physical layer control message that schedules multiple physical data channels for the communication device; and
transmitting or receiving transmissions on the multiple physical data channels scheduled by the physical layer control message, with the value of the transmission parameter (P) adapted across the multiple physical data channels according to the received RRC signaling.

37. The method of claim 36, wherein the RRC signaling indicates a rule, formula, sequence, or pattern according to which the value of the transmission parameter is to be adapted across multiple physical data channels scheduled by a single physical layer control message for the communication device.

38. The method of claim 37, wherein, according to the rule, formula, sequence, or pattern, the value of the transmission parameter is to be incremented or decremented across multiple physical data channels scheduled by a single physical layer control message for the communication device.

39. The method of claim 37, wherein the RRC signaling implicitly indicates the rule, formula, sequence, or pattern by indicating an index mapped to the rule, formula, sequence, or pattern, with different possible indices being mapped to respective rules, formulas, sequences, or patterns, wherein the index mapped to the rule, formula, sequence, or pattern is an index into a time domain resource allocation table.

40. The method of claim 37, wherein the single physical layer control message indicates a nominal value for the transmission parameter, and wherein the RRC signaling indicates a sequence of N offset values, wherein the value of the transmission parameter (P) for the Nth scheduled physical data channel is to be offset from the nominal value by the Nth offset value in the indicated sequence.

41. The method of claim 36, wherein the RRC signaling indicates how often the value of the transmission parameter is to be adapted across multiple physical data channels scheduled by a single physical layer control message for the communication device.

42. The method of claim 36, wherein the RRC signaling indicates one or more respective values of one or more variables in a rule, formula, sequence, or pattern according to which the value of the transmission parameter is to be adapted across multiple physical data channels scheduled by a single physical layer control message for the communication device.

43. The method of claim 42, wherein the one or more variables include a delta variable, wherein the value of the transmission parameter is to be adapted by the value of the delta variable between successive ones of multiple physical data channels scheduled by a single physical layer control message for the communication device.

44. The method of claim 43, wherein the single physical layer control message indicates the value of the transmission parameter for an earliest scheduled one of the multiple physical data channels, and wherein the one or more variables include a first delta variable and a delta adaptation variable, wherein:
the value of the transmission parameter is to be adapted by the value of the first delta variable between the earliest scheduled one of the multiple physical data channels and a second earliest scheduled one of the multiple physical data channels; and
the value of the transmission parameter is to be adapted by the value of a second delta variable between successive ones of multiple physical data channels after the second earliest scheduled one of the multiple physical data channels, wherein the second delta variable is a function of the value of the delta adaptation variable.

45. The method of claim 44, wherein:
$${P}_{2 nd PDCH} = {P}_{1 st PDCH} - {C}_{2 nd PDCH}$$
$${C}_{xth PDCH} = {C}_{2 nd PDCH} * [ ( x - 1 ) * {Δ}_{C} ]$$
$${P}_{xth PDCH} = {P}_{( x - 1 ) th PDCH} - {C}_{xth PDCH}$$
where P_{1st PDCH} is the value of the transmission parameter for the earliest scheduled one of the multiple physical data channels, P_{2nd PDCH} is the value of the transmission parameter (P) for the second earliest scheduled one of the multiple physical data channels, P_{xth PDCH} is the value of the transmission parameter for the xth scheduled one of the multiple physical data channels, C_{2nd PxSCH} is the first delta variable, Ac is the delta adaptation variable, and C_{xth PDCH} is the second delta variable.

46. The method of claim 42, wherein the one or more variables include:
an adaptation frequency variable N, wherein the value of the transmission parameter is to be adapted every Nth successive one of multiple physical data channels scheduled by a single physical layer control message for the communication device;
a first channel variable X and a last channel variable Y, wherein the value of the transmission parameter is to be adapted across physical data channels between the Xth scheduled one of the multiple physical data channels and the Yth scheduled one of the multiple physical data channels; and/or
a minimum parameter value variable THₘᵢₙ, and a maximum parameter value variable THₘₐₓ, wherein the value of the transmission parameter is to be adapted across multiple physical data channels scheduled by a single physical layer control message for the communication device, subjected to a constraint that the value of the transmission parameter is not to fall below the minimum parameter value variable THₘᵢₙ, and is not to exceed the maximum parameter value variable THₘₐₓ.

47. The method of claim 36, wherein the transmission parameter is a modulation and coding scheme (MCS) parameter, a resource block (RB) allocation parameter, or a frequency domain resource allocation parameter.

48. A method performed by a network node in a communication network, the method comprising:
transmitting, to a communication device, radio resource control (RRC) signaling indicating how a value of a transmission parameter is to be adapted across multiple physical data channels scheduled by a single physical layer control message for the communication device;
transmitting a physical layer control message that schedules multiple physical data channels for the communication device; and
transmitting or receiving transmissions on the multiple physical data channels scheduled by the physical layer control message, with the value of the transmission parameter adapted across the multiple physical data channels according to the transmitted RRC signaling.

49. The method of claim 48, wherein the RRC signaling indicates a rule, formula, sequence, or pattern according to which the value of the transmission parameter is to be adapted across multiple physical data channels scheduled by a single physical layer control message for the communication device.

50. The method of claim 49, wherein, according to the rule, formula, sequence, or pattern, the value of the transmission parameter is to be incremented or decremented across multiple physical data channels scheduled by a single physical layer control message for the communication device.

51. The method of claim 49, wherein the single physical layer control message indicates a nominal value for the transmission parameter, and wherein the RRC signaling indicates a sequence of N offset values, wherein the value of the transmission parameter for the Nth scheduled physical data channel is to be offset from the nominal value by the Nth offset value in the indicated sequence.

52. The method of claim 48, wherein the RRC signaling indicates one or more respective values of one or more variables in a rule, formula, sequence, or pattern according to which the value of the transmission parameter is to be adapted across multiple physical data channels scheduled by a single physical layer control message for the communication device.

53. The method of claim 48, wherein the transmission parameter is a modulation and coding scheme (MCS) parameter, a resource block (RB) allocation parameter, or a frequency domain resource allocation parameter.

54. A communication device comprising:
communication circuitry; and
processing circuitry configured to:
receive radio resource control (RRC) signaling indicating how a value of a transmission parameter is to be adapted across multiple physical data channels scheduled by a single physical layer control message for the communication device;
receive a physical layer control message that schedules multiple physical data channels for the communication device; and
transmit or receive transmissions on the multiple physical data channels scheduled by the physical layer control message, with the value of the transmission parameter adapted across the multiple physical data channels according to the received RRC signaling.

55. A network node configured for use in a communication network, the network node comprising:
communication circuitry; and
processing circuitry configured to:
transmit, to a communication device, radio resource control (RRC) signaling indicating how a value of a transmission parameter is to be adapted across multiple physical data channels scheduled by a single physical layer control message for the communication device;
transmit a physical layer control message that schedules multiple physical data channels for the communication device; and
transmit or receive transmissions on the multiple physical data channels scheduled by the physical layer control message, with the value of the transmission parameter adapted across the multiple physical data channels according to the transmitted RRC signaling.
